(19) United States
(12) Patent Application Publication
(10) Pub. No.: US 2025/0007931 A1
(43) Pub. Date: Jan. 2, 2025

(54) RISK ANALYSIS BASED NETWORK AND SYSTEM MANAGEMENT

(71) Applicant: Cisco Technology, Inc., San Jose, CA (US)

(72) Inventors: Manoj Kumar Shukla, Bhubaneswar (IN); Shankar Gopalkrishnan, Bangalore (IN)

(21) Appl. No.: 18/342,588

(22) Filed: Jun. 27, 2023

(51) Int. Cl. H04L 9/40

(52) U.S. Cl. CPC H04L 63/1425; H04L 63/1433

(57) ABSTRACT

Techniques are described for managing network traffic based on anomaly data. The anomaly data can be collected from network devices. A controller can identify, based on the anomaly data, identifiers, classifications, severities, and other characteristics, can be utilized to generate risk weights associated with the devices. The risk weights can be generated based on numbers of occurrences of the anomalies and the severities. Estimated risk scores associated with the devices can be generated based on the risk weights and anomaly frequencies associated with the classifications of the anomalies. The servers and the controllers can exchange communications with the devices to control the devices, and traffic associated therewith, based on the estimated risk scores.

### TECHNICAL FIELD

The present disclosure relates generally to techniques for utilizing risk analysis for network and system management.

### BACKGROUND

Networks and systems utilize devices of various types for routing data along traffic paths. For example, networks and systems of various types may operate network devices which are utilized to route data between computing devices. The networks and systems may utilize metrics, such as network metrics, to identify performance issues related to network devices. For example, network metrics may include bandwidth usage, packet loss, retransmissions, throughput, latency, network availability, connectivity, jitter, and so on. Network metrics may be monitored based on alerts and notifications associated with outages and errors experienced by the networks, and/or the network devices.

Troubleshooting and debugging of networks and systems may be performed by identifying problems and performing continuous and repeated testing of equipment in the networks and the systems. Mitigating actions may be performed after sources of the problems are identified. The troubleshooting and debugging may include discovering and correcting problems with connectivity, performance, security, and other aspects of the networks and the systems. The problems may be discovered and corrected by utilizing sets of procedures, practices, and tools to process requests of users and dispersed network assets and infrastructure. Corrections of the problems may enable the networks and the systems, and the equipment therein, which may experience downtime as a result of the outages and errors, to resume operation.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example topology of a computing and networking architecture for risk analysis based network and system management.

FIG. 2 illustrates an example topology of a computing and network architecture for identifying device anomalies and performing risk analysis for network and system management.

FIG. 3 illustrates a block diagram illustrating an example packet switching system that can be utilized to implement various aspects of the technologies disclosed herein.

FIG. 4 illustrates a block diagram illustrating certain components of an example node that can be utilized to implement various aspects of the technologies disclosed herein.

FIG. 5 is a computing system diagram illustrating a configuration for a data center that can be utilized to implement aspects of the technologies disclosed herein.

FIG. 6 shows an example computer architecture for a computing device (or network routing device) capable of executing program components for implementing the functionality described above.

FIG. 7 illustrates a flow diagram of an example method that illustrates aspects of the functions performed at least partly by the devices in the computing and networking architecture as described in FIG. 1.

### DESCRIPTION OF EXAMPLE EMBODIMENTS

### Overview

This disclosure describes techniques for managing networks and systems based on risk information. The risk information can be calculated, disseminated, and utilized to manage devices, and data traffic associated therewith. The devices can include various types of devices associated with the networks and the systems. Calculation of the risk information can be performed based on data, which can include various types of telemetry data associated with the networks and the systems, and the devices therein. Dissemination of the risk information can include transmission of the risk information to the devices, which can manage traffic routing based on the risk information. Utilization of the risk information can include managing the devices, the data traffic, and traffic routes based on the risk information.

Data associated with the network devices and the system devices can be utilized to calculate the risk information. Servers and controllers communicatively connected to the networks and systems can monitor the data periodically. The data can be monitored in real time or pseudo real time, and at times according to time intervals of various lengths. The time intervals can be identified based on default time intervals, and other time intervals. The other time intervals can include time intervals being identified via triggers, and time intervals being identified by selections via user input associated with users. Characteristics of the networks and the systems, and the devices therein, can be utilized to identify the time intervals. The data being identified periodically can enable behavior and operation of devices of the networks and the systems to be monitored and analyzed. The data can be utilized to generate reports and to predict trends in device behavior and device operation.

The risk information can be calculated based on the data captured by the networks and the systems. The risk information can include estimated overall risk factors associated with the devices. The estimated overall risk factors can be calculated based on the risk weights associated with the devices, devices anomalies, and anomaly frequencies. The anomaly frequencies can be associated with classifications of the anomalies experienced by the devices. The risk weights can be calculated based on severities and types of the anomalies, and numbers of occurrences of the anomalies. Anomaly characteristic information, which can include identifiers of the anomalies, the classifications, and the severities, can be identified based on the anomalies. The classifications can include various types of classifications, including software error classifications, hardware error classifications, and consistency check error classifications.

Risk information dissemination can include transmission of the risk information from controllers to the devices. The risk information can be disseminated via communications exchanged with the servers, the controllers, and the devices. The risk information can be generated and transmitted by the controllers. The risk information, which can be generated by the servers, can be received by the controllers and routed to the devices. The risk information being transmitted to and received by the devices can be utilized by the devices to manage traffic routing. The devices can receive data to be routed and utilize the risk information to analyze the data and characteristics associated with the data, which can include data sources, data destinations, routing paths, priorities, and any other types of characteristics. The devices can control data traffic, including routing of the data, based on the risk information.

Utilization of the risk information, which can include the routing of the data, can include different types of data routing management. The devices can be utilized to route and reroute the data to reduce likelihoods of data communication delays and failures. The devices can reroute the data by redirecting the data from devices associated with risk scores to other devices associated with other risk scores. The data can be rerouted based on the risk scores of the devices being greater than or equal to the other risk scores of the other devices. Rerouting of the data can be based on priorities associated with the data being different from other priorities associated with other data. Routing policy information can be distributed from the controllers and to the devices, and the devices can utilize the routing policy information to manage the routing and the rerouting of the data.

According to various implementations, any of the example methods described herein can be performed by a processor. For example, a device or system may include the processor and memory storing instructions for performing an example method, wherein the processor executes the method. In some implementations, a non-transitory computer readable medium stores instructions for performing an example method.

### Example Embodiments

This disclosure describes techniques for managing networks and systems, and traffic associated therewith, based on risk information. The risk information can be generated based on anomaly data associated with devices of the networks and the systems. Servers and controllers utilized to manage the networks and the systems can identify anomaly information, which can include anomaly characteristics, based on anomalies indicated by the anomaly data. The anomaly characteristics, which can include identifiers, classifications, severities, and other characteristics, can be utilized to generate risk weights associated with the devices. The risk weights can be generated based on numbers of occurrences of the anomalies and the severities. Estimated risk scores associated with the devices can be generated based on the risk weights and anomaly frequencies associated with the classifications of the anomalies. The servers and the controllers can exchange communications with the devices to control the devices, and traffic associated therewith, based on the estimated risk scores.

Generally, the techniques of this application improve the performance of various types of computing devices, which can include network devices, system devices, servers, controllers, and any other types of devices associated therewith, by reducing the amount of compute, network, and storage resources required to operate the computing devices. Unnecessary compute, network, and storage resources that would otherwise be required for operation of computing devices experiencing anomalies, and devices communicatively coupled to the computing devices experiencing anomalies, can be conserved based on risk information based network and system management. In some instances, storage resources of the computing devices experiencing anomalies and/or other devices that would interact with the computing devices experiencing anomalies, which would otherwise be expended for rerouting data based on data traffic routing incidents can be reallocated for other purposes. The data traffic routing incidents can include delays, failures, and any other types of incidents.

In various instances, the compute, network, and storage resources associated with devices experiencing anomalies, and/or the other devices that would interact with the computing devices experiencing anomalies, which would otherwise be expended, can be conserved by managing data traffic based on risk information generation, which utilizes information associated with the anomalies. In some examples, the compute, network, and storage resources associated with devices experiencing anomalies, and/or the other devices that would interact with the computing devices experiencing anomalies, can be conserved by utilizing the anomaly information to manage the computing devices, and the data traffic associated therewith, to reduce likelihoods of the incidents, including the delays and the failures.

Generally, the techniques of this application improve the performance of various types of networks by reducing amounts of network-based communications or traffic that. The network-based communications or traffic being reduced may include amounts of network-based communications or traffic that would otherwise be sent over one or more networks but is ultimately undesirable with respect to devices that experience anomalies, and/or the other devices that would interact with the computing devices experiencing anomalies. By limiting, preventing and/or rerouting network communications to and/or from the devices experiencing anomalies, and/or the other devices that would interact with the computing devices experiencing anomalies, network bandwidth usage can be conserved, network throughput can be increased, network latency can be improved, and packet loss occurrences can be minimized.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

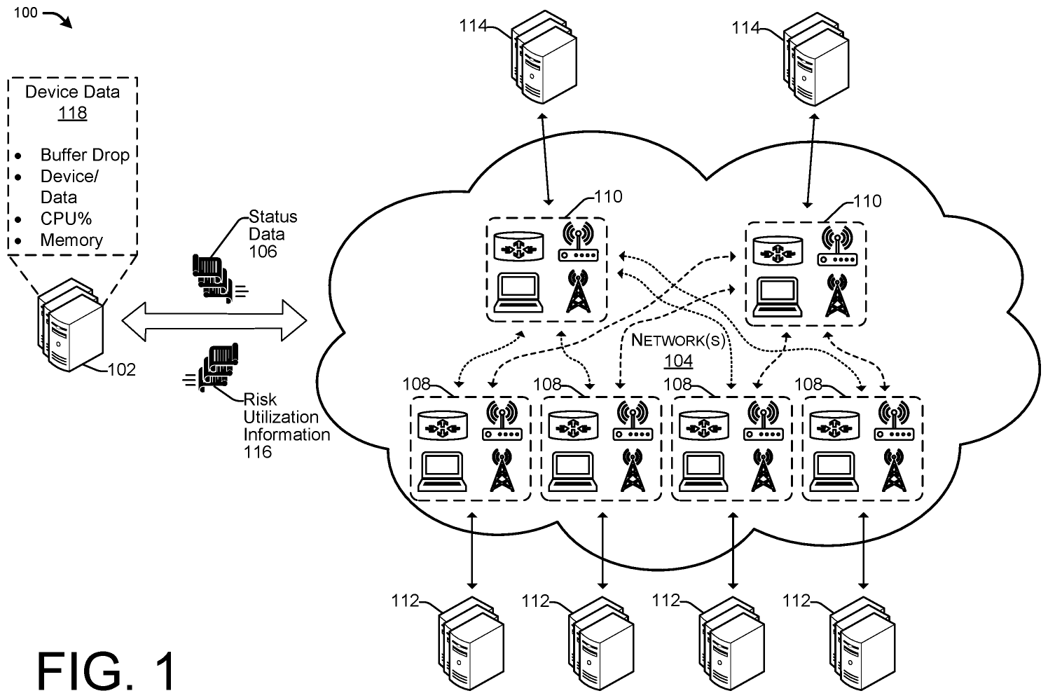

FIG. 1 illustrates an example topology of a computing and networking architecture 100 for risk analysis based network and system management. In various implementations, the computing and networking architecture 100 can include one or more controllers 102.

The controller(s) 102 can perform one or more risk analysis based operations (also referred to herein, simply, as “risk analysis”). The risk analysis based operation(s) can include identifying (e.g., determining, generating, calculating, computing, etc.) risk analysis based information (also referred to herein, simply, as “analysis information”) utilized to manage one or more networks 104, one or more systems, one or more devices associated therewith, one or more other networks, one or more other systems, one or more other devices, or any combination thereof. In some examples, the analysis information can be identified based on status data 106 associated with the network(s), the system(s), the device(s) associated therewith, the other network(s), the other system(s), the other device(s), or any combination thereof. The status data 106, as discussed below in further detail, can be determined, detected, and/or received by the controller(s) 102.

The analysis information can be identified for one or more devices associated with the network(s) 104, the system(s), the other network(s), the other system(s). In some examples, the device(s) can include one or more switches (e.g., one or more leaf switches (e.g., switches utilized to perform bridging and/or routing of data)) 108 and/or one or more routers 110, associated with, included in, and/or communicatively connected to, the network(s) 104. In those or other examples, the device(s) can include one or more computing devices (or “device(s)”) (e.g., one or more storage/management devices) 112 associated with the switches 108 and/or one or more computing devices (or “device(s)”) (e.g., one or more storage/management devices) 114 associated with the routers 110. The device(s) 112 and/or the device(s) 114 can be utilized to identify (e.g., determine, receive, collect, capture, store, etc.) any data associated with the switch(es) 108 and/or the router(s) 110. The data identified by the device(s) 112 and/or the device(s) 114 can include any data utilized by the switch(es) 108, and/or the router(s) 110, respectively, and/or any data utilized by the controller(s) 102.

Although the device(s) 112 and/or the device(s) 114 can be utilized to identify any data associated with the switch(es) 108 and/or the router(s) 110, as discussed above in the current disclosure, it is not limited as such. In some examples, at least one of the device(s) 112 and/or at least one of the device(s) 114 can be integrated with the switch(es) 108 and/or the router(s), respectively. In those or other examples, at least one of the device(s) 112 and/or at least one of the device(s) 114 can be separate from one another, or integrated together. In those or other examples, at least one of the device(s) 112 and/or at least one of the device(s) 114 can be separate from the controller(s) 102, or integrated together with at least one of the controller(s) 102, and/or any other device of the computing and networking architecture 100. In those or other examples, any functions of any of the device(s), being utilized to identify data (e.g., the data included in the status data 106), and/or being controlled based on the risk utilization information 116, as discussed throughout the current disclosure, can be implemented as being performed by the switch(es) 108, the device(s) 112, or any combination thereof, and/or as being performed by the router(s) 110, the device(s) 114, or any combination thereof, and/or as being performed by any other single device and/or combination of devices.

Although the device(s) 112 and/or the device(s) 114 can be utilized to identify any data associated with the switch(es) 108 and/or the router(s) 110, as discussed above in the current disclosure, it is not limited as such. In some examples, the switch(es) 108 and/or the router(s) 110 can perform some or all of the functions of the device(s) 112 and/or the device(s) 114, respectively, such as with at least one of the device(s) 112 and/or at least one of the device(s) 114 being excluded from the computing and networking architecture 100 altogether.

The analysis information can include various types of information utilized to identify one or more risk metrics (also referred to herein, simply, as “risk(s)”) of the network(s) 104, the system(s), the device(s) associated therewith, the other network(s), the other system(s), the other device(s), or any combination thereof. The identified risk(s) can be utilized to optimize one or more traffic routing strategies. The analysis information can include risk computation information, risk dissemination information, and risk utilization information.

The risk analysis based operation(s) can include one or more risk computation operations (also referred to herein, simply, as “risk computation”) to identify (e.g., determine, generate, calculate, compute, etc.) the risk computation information. In some instances, by identifying the risk computation information associated with a single device (e.g., a router, a switch, etc.), the risk computation information can be utilized to manage any portions of the network(s) 104, the system(s), the device(s) associated therewith, the other network(s), the other system(s), the other device(s), the data traffic therefore, or any combination thereof. Overall operational efficiency, reliability, customizability, longevity, and/or robustness of the network(s) 104, the system(s), the device(s) associated therewith, the other network(s), the other system(s), the other device(s), the data traffic therefore, or any combination thereof, can be improved utilizing the risk computation information and/or any other portions of the analysis information (e.g., the risk dissemination information, the risk utilization information, etc.).

The risk computation can be utilized to identify (e.g., determine, generate, calculate, compute, etc.) risk factor information (e.g., one or more risk factors), as discussed below in further detail. The risk factor(s) can, for example, represent a lack of “health” (e.g., operation with one or more anomalies) (e.g., a partial lack of health or an entire lack of health) (e.g., one or more at least partially unsuccessful operations) (e.g., characteristics, such as device characteristics, associated with the lack of health), or a health (e.g., one or more operations with an absence of the anomaly(ies) (e.g., one or more successful operations) (e.g., characteristics, such as device characteristics, associated with the health), or a combination thereof.

In some examples, the risk factor(s) can represent, for example, one or more predicted (e.g., potential) risks. In those or other examples, the risk factor(s) can, for example, represent a predicted lack of health (e.g., a potential lack of health) (e.g., one or more predicted at least partially unsuccessful operations) (e.g., potential at least partially unsuccessful operations) (e.g., characteristics, such as device characteristics, associated with a predicted lack of health (e.g., a potential lack of health), or a health (e.g., one or more predicted operations with an absence of the anomaly(ies) (e.g., potential operations with an absence of the anomaly(ies)) (e.g., one or more predicted successful operations) e.g., one or more potential successful operations) (e.g., characteristics, such as device characteristics, associated with the predicted health) (e.g., characteristics, such as device characteristics, associated with the potential health), or a combination thereof.

In various implementations, the risk computation can include identifying (e.g., determining, generating, calculating, computing, etc.) anomaly characteristic information (e.g., anomaly identifier information) (e.g., anomaly classification information), including one or more anomaly characteristics (e.g., one or more anomaly identifiers) (e.g., one or more anomaly classifications) (or “anomaly classes”) (also referred to herein, simply, as “classification(s)”), associated with the status data 106 (e.g., the anomaly data (e.g., the anomaly(ies))). The anomaly classification information can be included in the risk computation information.

The classification(s) can include at least one of the classification(s) being associated with one or more errors of various types, as discussed below in further detail, such as a software error classification (or “software classification”), a hardware error classification (or “hardware classification”), a consistency check error classification (or “consistency check classification”), any of other error classifications of other types, or any combination thereof.

In various implementations, the risk computation can include identifying (e.g., determining, generating, calculating, computing, etc.) anomaly characteristic information (e.g., anomaly type information), including one or more anomaly characteristics (e.g., one or more anomaly types), associated with the status data 106 (e.g., the anomaly data (e.g., the anomaly(ies))). The anomaly type information can be included in the risk computation information.

Individual ones of the anomaly type(s) can be identified for corresponding classifications of the anomaly classification(s). In some examples, the anomaly type(s) can be identified (e.g., determined, generated, calculated, computed, classified, etc.) as being within, and/or as part of, any of the classification(s), or in one or more of the classification(s). In those or other examples, the anomaly type(s) can be identified as one or more sub-classifications, in any of the classification(s), or in one or more of the classification(s).

In some examples, an anomaly can include a behavior of a behavior type that is not included from among a group of behavior types (e.g., behavior types being predetermined, normal, etc., or any combination thereof). In those or other examples, an anomaly can include an operation of an operation type that is not included from among a group of operation types (e.g., operation types being predetermined, normal, etc., or any combination thereof).

For example, at least one of the anomaly type(s) (e.g., a software process crash anomaly type of an anomaly, such as a software process crash anomaly (or “software process crash”) (or “process crash”)) (e.g., a syslog-error anomaly type of an anomaly, such as a syslog-error anomaly (or “syslog-error”) (or “syslog error”) can be identified for the software error classification, at least one of the anomaly type(s) can be identified for the hardware error classification. As another example, at least one of the anomaly type(s) can be identified for the consistency check error classification. As another example, at least one of the anomaly type(s) can be identified for any other type of error classification, etc.

For instance, with an example in which the anomaly is a syslog error, the syslog error can include an error (e.g., a previous error, a current error, a predicted error, etc., or any combination thereof) associated with a system logging protocol (or “syslog”). The syslog can include, for example, a process and/or method by which the device(s) use a message format (or a “standard” message format) to communicate with a server (e.g., a logging server, a controller, any other device, etc., or any combination thereof). The syslog can be utilized to monitor the device(s) easily and conveniently. For instance, with an example in which the anomaly is a process crash, the process crash can include a crash (e.g., a previous crash, a current crash, a predicted crash, etc., or any combination thereof) associated with a process being performed, a process that is scheduled to be performed, a process that is predicted to be performed, etc., or any combination thereof.

In various implementations, the risk computation can include identifying (e.g., determining, generating, calculating, computing, etc.) anomaly characteristic information (e.g., severity level information), including (one or more anomaly characteristics) (e.g., one or more severity levels), based on the status data 106 (e.g., the anomaly data (e.g., the anomaly(ies))). The severity level information can be included in the risk computation information.

In some examples, the severity level(s) can be identified based on the severity level(s) being associated with corresponding anomaly type(s). For example, a severity level with a value of “1” (e.g., a relatively greater severity level) can be identified as being associated with, and/or as representing, a severity of an anomaly type (e.g., a process crash type) in the software classification. In another example, a severity level with a value of “3” (e.g., a relatively lower severity level) can be identified as being associated with, and/or as representing, a severity of an anomaly type (e.g., a sys-log error type) in the software classification.

For example, a severity level with a value of “1” (e.g., a relatively greater severity level) can be identified as being associated with, and/or as representing, a severity of an anomaly type in the hardware classification. In another example, a severity level with a value of “3” (e.g., a relatively lower severity level) can be identified as being associated with, and/or as representing, a severity of an anomaly type in the hardware classification.

For example, a severity level with a value of “1” (e.g., a relatively greater severity level) can be identified as being associated with, and/or as representing, a severity of an anomaly type in the consistency check classification. In another example, a severity level with a value of “3” (e.g., a relatively lower severity level) can be identified as being associated with, and/or as representing, a severity of an anomaly type in the consistency check classification.

Although the severity levels can be identified based on the severity level(s) being associated with corresponding types, as discussed above in the current disclosure, it is not limited as such. In some examples, at least one of the severity levels can be identified based on the severity level(s) being associated with corresponding anomaly(ies), corresponding anomaly classifications(s), different occurrences of the anomaly(ies), etc., or any combination thereof.

For example, a relatively higher severity level can be identified as representing a relatively sever occurrence of a process crash, in comparison to relatively lower severity level can be identified as representing a relatively minor occurrence of a process crash. In some examples, a severity level with a value of “1” (e.g., a relatively greater severity level) can be identified as being associated with, and/or as representing, relatively greater severity of a classification (e.g., a software classification). In another example, a severity level with a value of “3” (e.g., a relatively lower severity level) can be identified as being associated with, and/or as representing, a severity of a classification (e.g., a hardware classification).

Any of the severity level(s) associated with corresponding anomaly(ies), corresponding anomaly classifications(s), different occurrences of the anomaly(ies), etc., can be utilized, alternatively or additionally to the severity level(s) associated with anomaly type(s). Any of the severity level(s) associated with corresponding anomaly(ies), corresponding anomaly classifications(s), different occurrences of the anomaly(ies), etc., can be utilized in a similar way as for the severity level(s) associated with anomaly type(s) to implement any of the techniques as discussed herein.

In various implementations, the risk computation can include identifying (e.g., determining, generating, calculating, computing, etc.) number of occurrences information, including one or more numbers of occurrences (or “occurrence number(s)”), based on the status data 106 (e.g., the anomaly data (e.g., the anomaly(ies))). In some examples, the number of occurrences information can be included in the risk computation information.

The number(s) of occurrences (or “number(s) of anomaly(ies)”) can include one or more numbers of occurrences (e.g., total number(s) of occurrences) associated with any portion of the risk computation information. The total number(s) of occurrences can include any all occurrences identified, without any time limitation. For example, the number(s) of occurrences can include at least one number of occurrences associated with at least one anomaly classification. In such an example or another example, a number of occurrences associated with an anomaly classification can be identified.

For example, the number(s) of occurrences can include at least one number of occurrences of at least one anomaly associated with at least one anomaly type. In such an example or another example, a number of occurrences of at least one anomaly associated with an anomaly type can be identified. In such an example or another example, a number of occurrences of at least one anomaly associated with an anomaly type or a group of anomaly types, and within any of the classification(s), can be identified. In such an example or another example, a number of occurrences of at least one anomaly associated with an anomaly type or a group of anomaly types, and within a single classification, can be identified.

Although the risk computation information (e.g., the number(s) of occurrences) can include various types of risk computation information (e.g., numbers of occurrences) being identified, as discussed above in the current disclosure, it is not limited as such. In various examples, any portion (e.g., any number of occurrence numbers) of the risk computation information can be identified in any of various ways. For example, any portions (e.g., any of the occurrence number(s)) of the risk computation information can be identified in real-time or between a period of time (e.g., a predetermined period of time).

In various implementations, the risk computation can include identifying (e.g., determining, generating, calculating, computing, etc.) risk weight information, including one or more risk weights, based on the status data 106 (e.g., the anomaly data (e.g., the anomaly(ies))). In some examples, the risk weight information can be included in the risk computation information.

In various examples, the risk weight(s) can be identified based on at least one portion of the risk computation information. The risk weight(s) can be utilized, for example, as a way to normalize the anomaly(ies) of various types occurring in various numbers. The risk weight(s) can include at least one relative risk weight associated with at least one anomaly that is at least one of the severity level(s) and that occurs at least one corresponding number of the occurrence number(s). By way of example, the risk weight(s) can include a risk weight (e.g., an anomaly risk weight) (e.g., a relative risk weight associated with each anomaly based on the severity of the anomaly) (e.g., a risk weight with a value of “1,” which can be a relatively greater risk weight) associated with an anomaly that has a relatively lower severity level (e.g., a severity level with a value of “3”) and that occurs at a relatively greater number of occurrences (e.g., 10 occurrences). In those or other examples, the risk weight(s) can include a risk weight (e.g., a relative risk weight) (e.g., a risk weight with a value of “1”) associated with an anomaly that has a relatively greater severity level (e.g., a severity level with a value of “1”) and that occurs at a relatively lower number of occurrences (e.g., 1 occurrences).

In some examples, the risk weight(s) can include one or more risk weights associated with one or more anomaly classifications (also referred to herein as “anomaly cluster(s)”). By way of example, a risk weight (e.g., a classification risk weight) associated with a classification can be identified based on i) an average anomaly risk weight associated with a group of anomalies in a classification, and ii) a sum of average anomaly risk weights of all classifications. In other words, the risk weight associated with the classification can be identified based on an average anomaly risk weight (e.g., an average anomaly weight corresponding to an average severity) of the classification, and a sum of average anomaly weights (e.g., a sum of average anomaly weights corresponding to average severity levels) of all classifications.

In various implementations, the risk computation can include identifying (e.g., determining, generating, calculating, computing, etc.) anomaly frequency information, including one or more anomaly frequencies, based on the status data 106 (e.g., the anomaly data (e.g., the anomaly(ies))). In some examples, the anomaly frequency information can be included in the risk computation information.

The anomaly frequency information can include at least one number of occurrences of at least one of the anomaly(ies) being repeated per a unit of time. In some examples, the number(s) of occurrences being identified, as discussed above, or at least one of any other number of occurrences of at least one of the anomaly(ies), can be utilized to identify the anomaly frequency(ies). In those or other examples, the time interval, or any other increment of time of any type, as discussed above, or at least one of any other time increment of any type, can be utilized to identify the anomaly frequency(ies).

In some examples, at least one anomaly frequency of the anomaly frequency(ies) being identified can include at least one anomaly frequency of at least one anomaly in any anomaly classification, at least one anomaly frequency of at least one anomaly of any anomaly type, at least one anomaly frequency of at least one anomaly of any anomaly severity level, or at least one anomaly frequency of at least one anomaly of any other type of group. In those or other examples, the anomaly frequency(ies) being identified can include at least one anomaly frequency of at least one anomaly in a single anomaly classification, at least one anomaly of a single anomaly type, at least one anomaly of a single anomaly severity level, or at least one anomaly of a single one of any other type of anomaly group or classification.

As a hypothetical example, at least one anomaly in a classification and of an anomaly type, such as a syslog error anomaly type in the software classification, which can be identified as having a severity level of “1,” can be utilized to identify an anomaly risk weight of at least one anomaly of a router in which the at least one anomaly occurs, and to identify a number of occurrences of the syslog error for the router over a period of time, such as, for example, over 1 hour. The number of occurrences can be utilized to identify the anomaly frequency of the at least one syslog error anomaly experienced by the router over the time period.

In various implementations, at least one portion of the risk computation information can be utilized to identify (e.g., determine, generate, calculate, compute, etc.) risk factor information, which can include the risk factor(s) associated with the device(s). In some examples, the risk factor(s) associated with the device(s) can be identified, for example, based on the anomaly(ies), the anomaly classification(s), the anomaly type(s), the anomaly severity level(s), the number(s) of occurrences, the risk weight(s), the anomaly frequency(ies), and so on, or any combination thereof.

As in the hypothetical example, as discussed above, a risk factor of a router can be identified based on the syslog error occurring, for example, 10 times over a time period of 1 hour. The risk weight of the router can be identified as being relatively greater than for other devices with fewer anomalies (e.g., fewer syslog errors). The risk factor of the router, based on the occurrences of the syslog error, can be utilized to manage the network(s) 104, the system(s), the device(s) associated therewith, the other network(s), the other system(s), the other device(s), the data traffic therefore, or any combination thereof. A router with more occurrences of an anomaly (e.g., even an anomaly of relatively lower severity), in comparison to another router with fewer occurrences of the anomaly, may be considered more risky than the other router.

Although the risk computation information can be identified utilizing various time increments, as discussed above in the current disclosure, it is not limited as such. For example, an increment of time utilized to identify a portion (e.g., the classification(s), the type(s), the occurrence number(s), etc.) of the risk computation information can be include a period of time between a first time (e.g., a year, a month, a day, an hour, a second, a millisecond, etc.)) and a second time (e.g., a year, a month, a day, an hour, a second, a millisecond, etc.).

The risk analysis based operation(s) can include one or more risk dissemination operations (also referred to herein, simply, as risk dissemination). In some examples, the risk dissemination can be performed based on the risk computation. In those or other examples, the risk dissemination can be performed utilizing at least one portion of the risk computation information.

In some examples, the risk dissemination can include the at least one portion of the risk computation information being identified, and utilized, by the controller(s) 102. In those or other examples, for instance with the risk computation being identified by at least one other device (e.g., a central server, etc.), the risk dissemination can include the at least one portion of the risk computation information being identified by at least one other device and at least one portion of the risk computation information being transmitted, by the at least one other device and to the controller(s) 102. The controller(s) 102 can receive the at least one portion of the risk computation information and utilize the at least one portion of the risk computation information for network, system, and/or device management. In some examples, the risk dissemination can include identifying the risk computation information, as risk dissemination information.

In some examples, the risk computation information can be transmitted via the risk dissemination based on information associated with the at least one other device and/or the controller(s) 102. The information associated with the at least one other device and/or the controller(s) 102 can include at least one identifier, such as a device identifier, a network identifier, etc.

The risk analysis based operation(s) can include one or more risk utilization operations (also referred to herein, simply, as risk utilization). In some examples, the risk utilization can be performed based on the risk computation and/or the risk dissemination. In those or other examples, the risk utilization can be performed utilizing risk utilization information 116, which can include at least one portion of the risk computation information. In some examples, the risk utilization information 116 can include the risk computation information and/or the risk dissemination information.

In some examples, the risk utilization can include transmitting, by the controller(s) 102, the risk utilization information 116. The risk utilization information 116 can be transmitted, by the controller(s) 102 and to at least one device (e.g., the network(s) 104, the system(s), the device(s) associated therewith, the other network(s), the other system(s), the other device(s), or any combination thereof). The at least one device receiving the risk utilization information 116 can control (e.g., route, reroute, divert, generate, terminate, etc., or any combination thereof), and/or be utilized to control, data traffic based on the risk utilization information. The at least one device can utilize the risk utilization information 116 to route, reroute, divert, generate, terminate, etc., or any combination thereof, data traffic.

In a hypothetical example, the controlling of the data traffic can be utilized to reroute traffic away a high-risk router to a relatively lower-risk router. The router, as discussed above, for example, which may be experiencing the syslog errors, may be relieved of at least a portion of data traffic related operations which would otherwise be performed by the router. The portion of data traffic related operations, which would otherwise be performed by the router, may be relieved based on the rerouting of the data traffic. The rerouting of the data traffic, which may utilized to relieve the router from the data traffic operations, may be performed by the at least one device receiving the risk information to increase operational efficiency, reliability, customizability, longevity, and/or robustness of the network(s) 104, the system(s), the device(s) associated therewith, the other network(s), the other system(s), the other device(s), the data traffic therefore, or any combination thereof.

Although data traffic may be rerouted, as discussed throughout the current disclosure, it is not limited as such. The rerouting of the data traffic may be performed in real-time or based on any of the time increments as discussed herein. Any of the at least one device (e.g., at least one of the switch(es) 108, the router(s) 110, the device(s) 112, the device(s) 114, any other device, or any combination thereof) receiving the risk utilization information 116 may perform the controlling based on the risk utilization information 116 according to time information (e.g., time information including the time period, the time interval, the time value, other time information, etc., or any combination thereof) in the risk utilization information 116. The time information can be generated and included in the risk utilization information 116, by the controller(s) 102, based on the risk utilization information 116.

The status data 106 can include various types of status data 106, which can include anomaly data, non-anomaly data, any other type of status data 106, or a combination thereof, associated with the network(s) 104, the system(s), the device(s) associated therewith, the other network(s), the other system(s), the other device(s), or any combination thereof. In various examples, the anomaly data can include data associated with one or more anomalies. In those or other examples, the anomaly(ies) can include one or more errors, one or more unsuccessful operations (e.g., one or more incomplete data transmissions, one or more incomplete data receptions, one or more incomplete data analysis operations, one or more of other unsuccessful data operations of other types, or any combination thereof), one or more of other anomalies of other types, or a combination thereof.

The error(s) can include at least one of various types of errors. In some implementations, the error(s) can include one or more software errors, one or more hardware errors, one or more consistency check errors (e.g., one or more errors associated with consistency of operations associated with hardware and software, such as, for any of the device(s)), one or more of other errors of other types, or any combination thereof. The software error(s) can include at least one of any of various types of software errors. The hardware error(s) can include at least one of any of various types of software errors. The consistency check error(s) can include at least one of any of various types of consistency check errors.

In various examples, the non-anomaly data can include data indicating one or more successful operations. In those or other examples, the non-anomaly data can be associated with one or more operations being performed in an absence of any of the anomaly(ies).

In some examples, the status data 106 can be received in one or more communications (e.g., one or more signals, one or more messages, one or more of any other types of communications, or any combination thereof) from the network(s) and/or the system(s). In some examples, the status data 106 can be identified based on information (e.g., one or more links, one or more software, or any combination thereof) received in the communication(s).

In some examples, the communication(s) can be received from one or more device(s) of at least one of the network(s), at least one of the system(s), at least one of other networks of other types, at least one of other networks of other types, or any combination thereof. The device(s), which can include at least one network device, at least one system device, any number of other devices of any other types, or any combination thereof, can include one or more routers, one or more switches, one or more servers, one or more user devices (e.g., one or more operator devices, one or more administrator devices, etc.), one or more endpoints, one or more border devices, one or more gateways, one or more laptops, one or more mobile devices, one or more tablets, and so on.

In some examples, the status data 106 can be identified based on operation of the network(s), the system(s), the device(s), and so on, and/or data (e.g., network data, system data, device data, at least one of other types of data, or any combination thereof) associated with the network(s), the system(s), the device(s), etc. In those or other examples, the device(s) can manage and/or utilize the status data 106, the network data, the system data, the device data, and/or the other type(s) of data, in various ways, the managing and/or utilizing including generating, processing, analyzing, routing, monitoring, storing, at least one of other functions of other types, or any combination thereof.

At least one of the device(s) can produce network, system, and/or device data, such as by operating as a point of generation and/or origination of data traffic. In those or other examples, at least one of device(s) can, without producing some or all of any network, system, and/or device data being managed or utilized by the at least one device, manage and/or utilized data produced elsewhere. For instance, the network, system, and/or device data may originate elsewhere for the server device to be able to provide to a user device. Alternatively or additionally, the network, system, and/or device data may pass through another network device (e.g., router, switch, etc.) on a path from a server device to a user device.

In various implementations, the device data which may be received by the controller(s) 102 can include various types of device data, including device data 118. The device data 118 can include at least one buffer drop value (e.g., an amount of a buffer drop and/or a time period between buffer drops) associated with at least one of the device(s), at least one device identifier and/or data identifier, at least one percentage of CPU usages, at least one amount of memory usage, and so on, or any combination thereof. The controller(s) 102 can utilize the device data, including the device data 118, to manage the data base on the status data 106 and/or the analysis information.

In some examples, the controller(s) 102 can route traffic to another device with relatively lower CPU utilization, based on the analysis data indicating the device being analyzed is relatively higher risk. In those or other examples, the controller(s) 102 can route traffic to another device with relatively lower CPU utilization, based on the analysis data indicating the device being analyzed has relatively higher CPU utilization (e.g., 93%) in comparison to a CPU utilization (e.g., 51%) of the other device.

In some examples, a high risk device can include a device with at least one risk factor at or above at least one corresponding risk factor threshold. In those or other examples, a low risk device can include a device with at least one risk factor below at least one corresponding risk factor threshold.

The controller(s) 102 can identify (e.g., determine, detect, and/or receive) the status data, and/or identify (e.g., determine, generate, calculate, compute, etc.) analysis information (e.g., the risk computation information, the risk dissemination information, etc.) in various ways. In some examples, at least one portion of the status data and/or at least one portion of the analysis information can be identified, dynamically, in real-time (or “pseudo real-time”). In those or other examples, the at least one portion of the status data and/or the at least one portion of the analysis information can be identified based on time information, trigger information, notification information, or any combination thereof.

In various implementations, the at least one portion of the status data and/or the at least one portion of the analysis information being identified in real-time can be identified as the at least one portion of the status data is being generated. For example, with instances in which any status data portion is identified in real-time, a status data portion and/or an analysis information portion can be identified as it is being generated (e.g., within a time (e.g., 1 picosecond 1 nanosecond, 1 millisecond, etc.) from generation) (e.g., within a time being less than or equal to a threshold time). In such an example or another example, the status data portion and/or the analysis information portion can be identified by the controller(s) 102 based on the status data being transmitted to, and received by, the controller(s) 102 in the communication(s).

In various implementations, the status data and/or the analysis information being identified based on the time information can include the status data, the device data, and/or the analysis information being identified based on a time period, a time interval, a time value, or one or more other types of time information, or any combination thereof. In some examples, the status data and/or the analysis information can be identified based on the controller(s) 102 identifying that a current time from a previous time at which the status data and/or the analysis information was identified is equal to or greater than the time period (e.g., an amount of time, which can include a predetermined amount of time). In those or other examples, the time period can vary for each of the times at which the status data and/or the analysis information is identified, based on operation data associated with the system(s) and the network(s). The operation data can include bandwidth usage, packet loss, retransmissions, throughput, latency, network availability, connectivity, jitter, or one or more other types of operation data, or any combination thereof.

In various implementations, the time interval can include an amount of time at which the status data and/or the analysis information is identified based on previous times, on an ongoing basis. The status data can be identified (e.g., determined, detected, and/or received) and/or the analysis information can be identified (e.g., determined, generated, calculated, computed, etc.) each time an amount of time from the previous time at which the status data was identified is identified as being equal to or greater than the time interval. The time value can include a value (e.g., a year, a month, a day, an hour, a second, a millisecond, etc.) of a time at which the status data and/or the analysis information can be identified.

In various implementations, the notification information can include one or more notifications being identified and utilized to identify (e.g., determine, detect, and/or receive) the status data and/or the analysis information. At least one of the notification(s) can be identified based on at least one selection via user input to the controller(s) 102, based on at least one message being identified by the controller(s) 102, at least one other type of notification being identified, or any combination thereof.

The at least one message can be received from a device (e.g., any of the device(s) of the network(s) 104, and/or any device of any other network and/or system), which can include the status data 106, and/or which can be utilized (e.g., as a trigger) to generate the analysis information based on the status data 106 being transmitted (e.g., transmitted at least partially or entirely separately from the message). In some examples, the at least one message can be received from the device transmitting the message indicating based on at least one request from the controller(s) 102. The at least one request can be transmitted based on the controller(s) identifying that at least one metric (e.g., at least one metric associated with the anomaly(ies), the anomaly classification(s), the anomaly type(s), the anomaly severity level(s), the number(s) of occurrences, the risk weight(s), the anomaly frequency(ies), and so on, or any combination thereof) meets or exceeds a corresponding threshold metric (e.g., at least one corresponding threshold metric associated the anomaly(ies), the anomaly classification(s), the anomaly type(s), the anomaly severity level(s), the number(s) of occurrences, the risk weight(s), the anomaly frequency(ies), and so on, or any combination thereof).

In those or other examples, the at least one message can be transmitted by the at least one device based on the at least one device identifying a time interval meeting or exceeding a threshold time interval. The at least one device can transmit the at least one message, for example, based on identifying an amount of time from a time at which a previous message was transmitted is identified as being equal to or greater than a time interval (e.g., a time period, a time interval, etc.).

Although the at least one message to identify (e.g., request) the status data 106 and/or identify (e.g., generate) the analysis information can be received in various ways, such as based on the at least one request from the controller(s) 102, as discussed above in the current disclosure, it is not limited as such. In some examples, the at least one message can be received from at least one device (e.g., any of the device(s) of the network(s) 104, and/or any device of any other network and/or system). In some examples, the at least one message can be received from the at least one device transmitting the message indicating based on the at least one device identifying at least one metric (e.g., at least one metric associated with status data 106, and so on, or any combination thereof) meets or exceeds a corresponding threshold metric (e.g., at least one corresponding threshold status data metric).

In some examples, the metric can be associated with a metric (e.g., an amount of anomaly information) (e.g., a number of anomaly(ies)) identified by the at least one device being greater than a corresponding threshold metric (e.g., a corresponding threshold amount) (e.g., a threshold number of anomaly(ies)). In those or other examples, the metric can be associated with an amount of anomaly information (e.g., a number of anomaly(ies) in at least one of the anomaly classification(s), a number of anomaly(ies) of the anomaly type(s), a number of anomaly(ies) of the anomaly severity level(s), a number(s) of occurrences, an amount of anomaly frequency(ies)) identified by the at least one device being greater than a corresponding threshold amount (e.g., a corresponding threshold associated with a number of anomaly(ies), a number of anomaly(ies) in at least one of the anomaly classification(s), anomaly(ies) of the anomaly type(s), anomaly(ies) of the anomaly severity level(s), a number(s) of occurrences, an amount of anomaly frequency(ies)). The device can identify the metric(s) exceeding the threshold metric(s) of various types based on information utilized for, and/or required to perform, the identifying being received from the controller(s) 102.

In some instances, by utilizing severity level(s) to represent anomaly(ies) associated with corresponding classification(s), any of the anomaly(ies) in a classification of a type can be identified as having the same severity level as at least one of others of the anomaly(ies) in the classification of the same type. The anomaly(ies) and the severity level(s) can be identified, tracked, stored, and/or utilized in the risk computation, the risk dissemination, and/or the risk utilization, to manage devices with anomaly(ies) in the relatively higher severity classification(s) (e.g., classification(s) with relatively higher severity level(s), sooner, more carefully, more thoroughly, etc., or any combination thereof, in comparison to devices with anomaly(ies) in the relatively lower severity classification(s) (e.g., classification(s) with relatively lower severity level(s). For example, managing devices with anomaly(ies) in the relatively higher severity classification(s), and/or other devices of the same type, network location, etc. as the devices with the higher severity classification(s), sooner, more carefully, more thoroughly, etc., can include allocating relatively more compute, network, and storage resources, scheduling processes, operations, transmissions, computations, sooner, more carefully, more thoroughly, etc., and so on.

The requests(s) transmitted by the controller(s) 102 and/or the message(s) transmitted by the device, which can be utilized by the controller(s) 102 to identify request the status data 106 and/or generate the analysis information, can be transmitted based on the relatively higher severity level(s) being identified. At least one transmission of the requests(s) by the controller(s) 102 and/or the message(s) by the device(s) can be performed based on the device(s) being identified as being associated with anomaly(ies) of the relatively higher severity level(s).

Although the controller can perform the risk analysis based operations, as discussed above in the current disclosure, it is not limited as such. In some examples, any of the risk analysis based operation(s) (e.g., the risk computation, the risk dissemination, the risk utilization, and so on, or any combination thereof, can be performed by at least one of any portions, individually or together, of the network(s) 104, the system(s), the device(s) associated therewith, the other network(s), the other system(s), the other device(s), or any combination thereof.

Although the status data 106, which can be identified by the device(s), and which can be transmitted by the device(s) and to the controller(s) 102, can include various type of data (e.g., device data and/or status data associated with the device(s), as discussed above in the current disclosure, it is not limited as such. In some examples, the status data 106 can include anomaly identifier data, which can include one or more anomaly identifiers (or “identifier(s)”) of the anomaly(ies). At least one of anomaly identifier(s), which can be included in the status data 106, can be utilized as at least one of the anomaly identifier(s) in the anomaly characteristic information.

Although the terms “time interval(s),” “time period(s),” “time value(s),” etc. are utilized, for purposes of convenience and clarity of explanation, with respect to identification of the status data 106 and the risk analysis information, as discussed above in the current disclosure, it is not limited as such. Any of the functions being performed at any of the “time interval(s),” “time period(s),” “time value(s),” etc. can be implemented at a single time period and/or regular time intervals from other functions, and/or at a particular time value (e.g., a point in time, such as a predetermined point in time), for purposes of any of the techniques as discussed herein.

Although the terms “anomaly” and “occurrence” are utilized in a various ways as discussed above in the current disclosure, it is not limited as such. In various examples, either of the terms “anomaly” and “occurrence” can refer to a single anomaly, multiple occurrences of an anomaly, an anomaly occurring repeatedly, a single occurrence of an anomaly, etc., or any combination thereof.

In a hypothetical example, risk based-based adaptive traffic engineering (e.g., engineering being implemented, such as via the computing and network architecture 100) can be utilized in a datacenter to determine an overall risk of a network router. The risk can be determined using cluster-based anomaly segregation and dynamic weighted risk computation. The risk based-based adaptive traffic engineering can be utilized to provide controller-assisted rerouting of data. The risk-based adaptive traffic engineering can be performed using the overall risk of a network router to optimize a traffic routing strategy in the datacenter. An overall performance and reliability of the datacenter can be improved by reducing a risk of single point of failure (e.g., reducing a risk of a router failure) and any cascading failures, in order to improve an overall network's resiliency.

In the hypothetical example, any network outages and/or any disruptions caused by switch/router failures in datacenters can be minimized and/or prevented with the help of controllers according to the techniques as discussed herein. The controllers may be utilized to prevent failures, such as failures which may otherwise occur in existing systems due to anomalies in routers. The controllers being operated according to the techniques as discussed herein may be utilized to proactively assess risks of anomalies, and to enable traffic to be rerouted from routers. The traffic may be rerouted in a timely manner to significantly reduce network downtime. While systems operating according to conventional techniques undergo various types of router failures resulting in network outages and disruptions, the systems being operated according to the techniques as discussed herein effectively assess and mitigate risks of router failures proactively, thereby avoiding costly network outages and disruptions.

In the hypothetical example, the systems operating according to the techniques as discussed herein, which utilize risk-based adaptive traffic engineering to provide centralized controllers that proactively assess risks of routers, take overall risks into account. Calculating and taking the overall risks into account enable the systems to perform dynamic and efficient traffic rerouting, and to also avoid failures due to routers that are, partially or completely, high-risk. Overall performance, reliability, and resiliency of the networks and systems operating according to the techniques as discussed herein are improved by computing the overall risks potentially resulting from anomalies within the routers and using the overall risks to perform partial or complete avoidance of traffic passing through the potentially “problematic” routers using controllers to prevent network outages.

In the hypothetical example, an overall risk of a network router can be computed and utilized to optimize a traffic routing strategy in a datacenter. Overall performance and reliability of the datacenter may be reduced, by reducing a risk of single point (e.g., a single router failure), and/or cascading failures, and also by improving an overall resiliency of a network.

In hypothetical example, an overall risk may be calculated and utilized for network and/or system management based on three parts. In a first part, clusters of risks may be determined, and anomalies under each risk cluster may be determined. A periodic check may be performed for anomalies. A percentage of an anomaly occurrence in each cluster may be determined and utilized to calculate an overall risk level. The overall risk level for a router may be calculated by multiplying a dynamic weightage factor of each cluster with a percentage value. By deriving a weight dynamically, rather than assigning a random weight (e.g., although not excluding any assignments of random weights in some implementations, if desirable for any reason), an overall risk computation may be accurately computed.

In hypothetical example, according to the first part of network and/or system management, anomalies in a router can be classified into pre-defined classes. The pre-defined classes can include, for example, a number of classes (e.g., “3” classes) of anomalies, including classes associated with a “software error,” a “hardware error,” and a “consistency check.” Within each class of anomaly, multiple anomalies of various types may be included. As an example of the software error class, anomalies in the software error class may include a process crash, a syslog error, etc., or any combination thereof. A severity-level associated with each anomaly may be assigned. For example, a process crash may be assigned as having a severity-level of “1;” and a syslog-error may be assigned as having a severity-level of “3.” Anomalies and severity levels may be assigned for each of the other classes (e.g., the hardware error class, the consistency check error class, etc.).

In hypothetical example, according to the first part of network and/or system management, a “relative risk weight” for an anomaly (e.g., a type of anomaly) may be computed by factoring both a “number of occurrences” and a “severity level” associated with each anomaly based on a function (e.g., a function based on a severity level and a number of occurrences of anomalies) to determine the relative risk weight. For example, “10” occurrences of anomalies with a severity level of “3” may be calculated, with the function, as being equivalent to one occurrence of an anomaly with a severity level of “1.” The function and the anomaly frequency of each class of anomalies may be utilized to calculate an estimate of an overall risk factor for each router (e.g., a router with more occurrences of lower severity anomalies may be considered less risky compared to a router with fewer occurrences of higher severity anomalies).

In the hypothetical example, a second part of the overall risk being calculated and utilized for network and/or system management may include the overall risk of the router that was computed being then sent to a controller. For example, the overall risk of a router that was computed may be sent to the controller which, in turn, may propagate the overall risk to all the routers in the network, allowing the routers to make informed decisions about traffic routing.

In the hypothetical example, a third part of the overall risk being calculated and utilized for network and/or system management may include using overall risk information based on the overall risk being calculated to reroute traffic from high risk routers in two ways. In a first way, rerouting can include traffic with a high differentiated services code point (DSCP) value being redirected by downstream neighboring routers at an egress (e.g., a network location) to other low risk routers. While the traffic with the high DSCP value is redirected by downstream neighboring routers at the egress to other low risk routers, low priority traffic (e.g., traffic with a low DSCP value) can be redirected to high overall risk routers.

In the hypothetical example, with respect to the third part of the overall risk being calculated and utilized for network and/or system management, a second way of rerouting can include rerouting traffic from a router (e.g., a high risk router) to low risk routers by using a pre-defined routing policy template. The pre-defined routing policy template may be pushed from the controller to any of the routers (e.g., network engineers may be given flexibility to identify to which low risk routers traffic is to be rerouted to, via controller the controller).

In the hypothetical example, by utilizing the techniques as discussed herein, such as for systems and networks utilizing a virtual private cloud (vPC) infrastructure, and/or a virtual extensible local area network (VxLAN) infrastructure, in a datacenter (e.g., even though there is physical and control plane isolation), outage issues, which may still otherwise occur in existing systems due to a lack of proactive risk assessments, may be prevented. Risk assessments can be perform in real-time, enabling traffic routing to be adaptive while risk mitigation steps can be performed via network controllers (e.g., commercial network controllers), thus resulting in improved network resilience. Downtimes may be significantly reduced; and network management may be optimized.

In the hypothetical example, an anomaly may refer to any unusual behavior, and/or any deviation from normal operation, in a network device, such as a router, which may lead to performance degradation in a network. Anomalies may be selected (e.g., selected for purposes of the network and/or system management according to the techniques as discussed herein) based on potential impacts of the anomalies on a corresponding router (e.g., a router experiencing the anomaly), and/or any other router, and, therefore, the network. The anomalies may categorized into the “3” classes based on various characteristics (e.g., a software critical characteristic, a hardware critical characteristic, a consistency critical characteristic, or any other characteristic, or any combination thereof).

In the hypothetical example, the anomalies may include, and/or be associated with, parity errors (e.g., single bit parity errors, multibit parity errors, etc.), cyclic redundancy check (CRC) errors, ternary content addressable memory (TCAM) exhaustion errors, too many mac moves errors, too much of broadcast, unknown unicast, and multicast (BUM) errors (e.g., storm control drop errors), interface drops due to funnel errors (e.g., multiple ports to single output port errors), and so on, or any combination thereof. In various cases, the anomalies may include, and/or be associated with, fan faulty/shutdown errors, fans redundancy check errors, power supply unit (PSU) faulty/shutdown errors, transceiver signal to noise (SNR) check errors, transceiver temperature check errors, router temperature threshold check errors, any other errors of various types (e.g., errors in the hardware critical class), or any combination thereof. In various cases, the anomalies may include, and/or be associated with, control plane policing (CoPP) consistency check errors, port-state consistency check errors, virtual private cloud (vPC) consistency check errors, data management engine (DME) consistency check errors, virtual extensible local area network (VxLAN) consistency check errors, and so on, or any combination thereof.

In the hypothetical example, anomalies may be categorized into “3” severity levels, such as levels of a “severity 1,” a “severity 2,” and a “severity 3” (e.g., although any number of severity levels may be utilized). For example, the “severity 1” may represent the most critical anomalies, while the “severity 3” may represent the least critical anomalies, and the “severity 2” may represent moderately critical anomalies. To enable the “severity 1” anomalies to be given the highest weight, a weighting factor of “10” may be assigned to them. Similarly, a weight of “5” may be assigned to the “severity 2” anomalies, while a weight of “1” may be assigned to “severity 3” anomalies. The weightings of “1,” “5,” and “10” for “severity 3,” “severity 2,” and “severity 1” anomalies, respectively, may be utilized to represent relative impacts of each of the types of anomalies on the network's overall risk. For example, “severity 1” anomalies, which may be likely to have the highest impact on the network, may be weighted the highest at “10.” The “severity 2” anomalies, which may be also significant, but not as severe as the “severity 1” anomalies, may be weighted at “5.” The “severity 3” anomalies, which may be the least severe anomalies, but which may still need to be considered in overall risk calculations, may therefore be weighted at “1.”

In the hypothetical example, for each cluster, a weight may be calculated by factoring in a severity level and a number of occurrences of each anomaly of an individual cluster. For examples, an average severity and/or an average weight for each cluster may be calculated and then used to calculate a weight for each cluster, by dividing the average severity (e.g., the average weight) of each group of severities (e.g., of each group of weights) by a sum of all of the average severities (e.g., a sum of all the average weights). For example, for a software critical cluster with anomalies, which may include a “severity 1” anomaly of weight “10,” a “severity 1” anomaly of weight “10,” a “severity 1” anomaly of weight “10,” a “severity 1” anomaly of weight “10,” and a “severity 1” anomaly of weight “10,” an “average severity” (e.g., an average weight) may be calculated as “7.2” (e.g., 10+10+10+5+1)/5=7.2). Calculating the “average severities” of each cluster may be performed to ensure weights of each cluster are proportional to an average severity of each cluster.

In the hypothetical example, a sum of average severities of all clusters for a router may be calculated by adding average severities for all clusters (e.g., “7.2,” for the software critical cluster, being added to an average severity value of the hardware critical cluster, such as “3.4” (for example, such as for an instance in which “5” hardware critical anomalies of various weights occurred), and being added to an average severity value of the consistency critical cluster, such as 2.857 (for example, such as for an instance in which “7” consistency critical anomalies of various weights occurred), may equal “13.457”). The sum of the average severities may be utilized to calculate a dynamic weight for each cluster (e.g., a dynamic weight of the software critical cluster may be calculated by dividing the average severity of the software critical anomalies by the sum of the average severities of all clusters (e.g., 7.2/13.457=0.535) (e.g., a dynamic weight of the hardware critical cluster may be calculated by dividing the average severity of the software critical anomalies by the sum of the average severities of all clusters (e.g., 3.4/13.457=0.252) (e.g., a dynamic weight of the consistency critical cluster may be calculated by dividing the average severity of the software critical anomalies by the sum of the average severities of all clusters (e.g., 2.857/13.457=0.212).

In the hypothetical example, for each cluster, a percentage occurrence of anomalies may be calculated by dividing a number of occurrences of anomalies in the cluster by the total number of anomalies in that cluster (e.g., a percentage occurrence may be calculated at a constant time interval, such as “1” minute, “5” minutes, etc., by a controller). For example, at a time interval (e.g., a time interval of “time1”), anomalies may include “2” software critical anomalies, “3” hardware critical anomalies, and “3” consistency critical anomalies. A percentage occurrence of each cluster can be derived as “40%” (e.g., ⅖) for software critical anomalies, “60%” (e.g., ⅗) for hardware critical anomalies, and “42.85%” (e.g., 3/7) for consistency critical anomalies.

In the hypothetical example, a “severity 1” level risk and an overall risk for the router can be calculated. A “severity 1” level risk percentage at the time interval “time1” may be calculated as a total of “severity 1” anomalies at the time interval “time 1” in all classes (e.g., such as “6” total “severity 1” anomalies at the time interval “time1”). The total of the “severity 1” anomalies at the time interval “time1” in all classes may be divided by a sum of totals of all of the classes of anomalies (e.g., a total of software critical anomalies at the time interval “time1” (e.g., “2” software critical anomalies at the time interval “time1”)) (e.g., a total of hardware critical anomalies at the time interval “time1” (e.g., “3” hardware critical anomalies at the time interval “time 1”)) (e.g., a total of consistency critical anomalies at the time interval “time1” (e.g., “5” consistency critical anomalies at the time interval “time1”)), which may be multiplied by 100 (e.g., 6/(2+3+5)*100=60%).

In the hypothetical example, a severity of an overall risk for the router can be calculated by multiplying a weight of each cluster by its respective occurrence percentage at that time interval (e.g., the time interval “time 1”), and by then calculating a sum of the products (e.g., the products of the weights of all clusters being multiplied by respective occurrence percentages). For example, the overall risk of the router for the time interval “time1” can be calculated as 45.6% (e.g., (0.535*.4)+(0.252*.6)+(0.212*.4285)=0.456*100).

In the hypothetical example, for determining whether a router is at risk, both the overall risk, and/or the risk percentage of the “severity 1” anomalies, may be considered. For example, if either the overall risk or the “severity 1” anomalies risk percentage is above a predetermined threshold, a controller may declare the router to be at “high risk” (e.g., however, even if the overall risk is well within the predetermined threshold, the router may still be declared as risky (e.g., “high risk”) if the percentage of the “severity 1” anomalies is above a predetermined threshold, indicating that the router is vulnerable). As an example, a router may be declared to be “high risk” if the overall threshold is greater than or equal to 60% (e.g., although, any percentage, such as 30%, 40%, 50%, 60%, 70%, etc., may be utilized) or if the “severity 1” level risk percentage is greater than or equal to 40% (e.g., although, any percentage, such as 30%, 40%, 50%, 60%, 70%, etc., may be utilized).

In the hypothetical example, a standard deviation may be maintained between the weights, which may be assigned to different severity levels, to ensure that “false positive results” are minimized. For example, a “severity 1” anomaly may be assigned a weight (e.g., a weight of “10”) to reflect an impact of the “severity 1” anomaly being the “same as ten “severity 3” anomalies, which may be assigned a different weight (e.g., a weight of “1”). By assigning appropriate weights according to the severity level, and by maintaining the standard deviation, a risk calculation with a higher level of accuracy may be achieved.

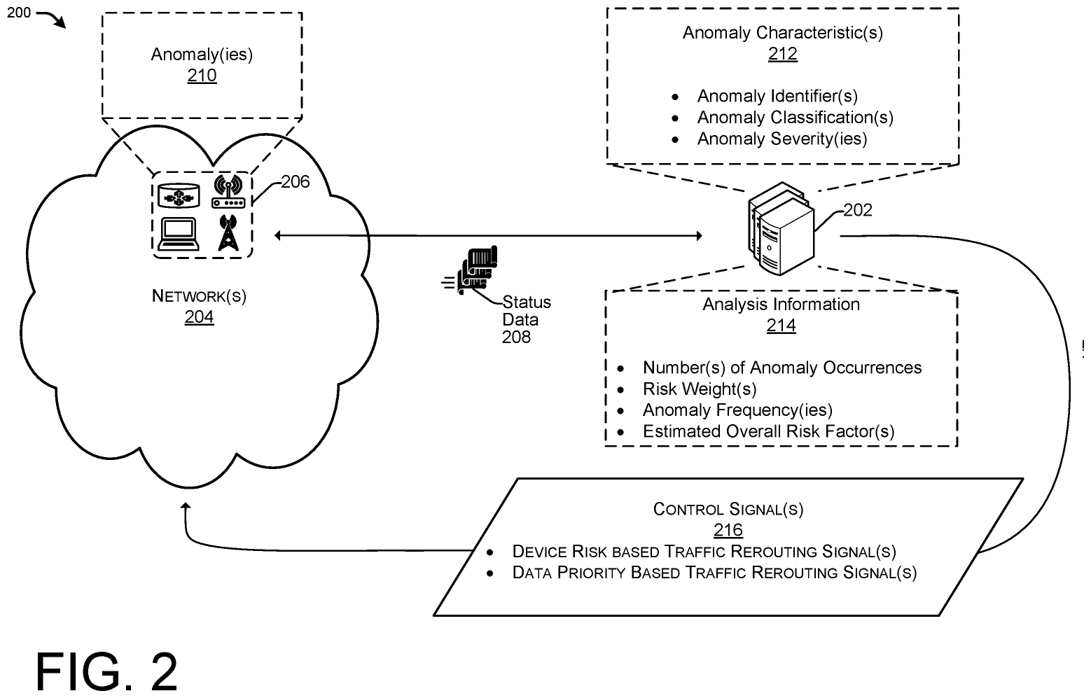

FIG. 2 illustrates an example topology of a computing and network architecture 200 for identifying device anomalies and performing risk analysis for network and system management. In some examples, the architecture 200 comprises a controller 202, one or more networks 204, and a network and/or system device (or “device”) 206. The network(s) 204 can include any number of devices. In those or other examples, the controller 202 can be implemented as one of the controller(s) 102, as discussed above with reference to FIG. 1. In those or other examples, at least one of the network(s) 204 can be implemented as at least one of the network(s) 104, as discussed above with reference to FIG. 1. In those or other examples, the device 206 can be implemented as at least one of any of the device(s) (e.g., a switch 108, a router 110, a device 112, a device 114, or any other network and/or system device) in the computing and networking architecture 100, as discussed above with reference to FIG. 1.

In some examples, the controller 202 can identify status data 208, which can include any portion of the status data 106, and/or be included in the status data 106, as discussed above with reference to FIG. 1. The status data 208, which can include data (e.g., device data, status data, the anomaly identifier(s), or any combination thereof) associated with one or more anomalies 210 associated with the device 206. The status data 208 can be transmitted by the device 206 and to the controller 202.

In various examples, the controller 202 can identify anomaly characteristic information, any of which can be implemented as any of the anomaly characteristic information as discussed above with reference to FIG. 1. The anomaly characteristic information can include one or more anomaly characteristics 212, any of which can be implemented as any of the anomaly characteristic(s) as discussed above with reference to FIG. 1. The anomaly characteristic(s) 212 can include one or more anomaly identifiers, one or more anomaly classifications (e.g., a software classification, a hardware classification, a consistency check classification), one or more anomaly severities, and/or any other anomaly characteristic(s) (e.g., one or more anomaly types).

The controller 202 can identify analysis information 214, any of which can be implemented as any of the analysis information as discussed above with reference to FIG. 1. In some examples, the analysis information 214 can include any type of information, including number of occurrences information (e.g., one or more numbers of anomaly occurrences), risk weight information (e.g., one or more risk weights), anomaly frequency information (e.g., one or more anomaly frequencies), risk factor information (e.g., one or more risk factors, such as one or more estimated overall risk factors (also referred to herein, simply, “overall risk”), and/or any other portion of the analysis information.

In some examples, the software classification can be identified based on one or more anomalies associated with the software classification. For example, the anomaly(ies) 210 can include at least one anomaly associated with the software classification can include at least one parity error (e.g., at least one single bit parity error, at least one multibit parity error, etc.), at least one cyclic redundancy check (CRC) error, at least one ternary content addressable memory (TCAM) exhaustion error, at least one too many mac moves error, at least one too much of broadcast, unknown unicast, and multicast (BUM) error (e.g., storm control drops error), at least one interface drops due to funnel error (e.g., at least one multiple ports to single output port error), and so on, or any combination thereof.

In some examples, the hardware classification can be identified based on one or more anomalies associated with the hardware classification. For example, the anomaly(ies) 210 can include at least one anomaly associated with the hardware classification can include at least one fans faulty/shutdown error, at least one fans redundancy check error, at least one power supply (PSU) faulty/shutdown error, at least one transceiver signal to noise (SNR) error, at least one SNR check error, at least one transceiver temperature check error, at least one router temperature threshold check error, and so on, or any combination thereof.

In some examples, the consistency check classification can be identified based on one or more anomalies associated with the consistency check classification. For example, the anomaly(ies) 210 can include at least one anomaly associated with the consistency check classification can include at least one control plane policing (CoPP) consistency check error, at least one port-state consistency check error, at least one virtual private cloud (vPC) consistency check error, at least one data management engine (DME) consistency check error, at least one virtual extensible local area network (VxLAN) consistency check error, and so on, or any combination thereof.

In various implementations, the severity information can include at least one of any number of severities. For example, three severities of different levels can be utilized for identifying the severity information associated with the anomaly(ies) 210. The severity levels can include the three severity levels, including “severity 1,” “severity 2,” and “severity 3.” In some examples, severity 1 may represents the most critical anomalies, while severity 3 represents the least critical anomalies, and severity 2 represents moderate critical anomalies between severity 1 and severity 3.

In some examples, to ensure that severity 1 anomalies are given a highest weight (or “weighting factor”), a weighting factor of “10” may assigned to them; a weight of “5” may be assigned to severity 2 anomalies, and a weight of “1” may be assigned to severity 3 anomalies. In some examples, the weights of “1,” “5,” and “10” for severity 3, severity 2, and severity 1 anomalies, respectively, may be chosen based on relative impacts of each type of anomaly on an overall risk to the network(s) 204. For example, severity 1 anomalies may likely to have the highest impact on the network and thus are given the highest weigh of “10.” Severity 2 anomalies, which may also be significant, but not as severe as severity 1 anomalies, may be given the weight of “5.” Severity 3 anomalies, which may be the least severe, but which may still need to be considered in overall risk calculations, may be given the weight of “1.”

In some examples, the overall risk associated with the device 206 may be calculated according to an equation 1, shown below:

$$( ( a software critical weight * a software critical percentage ) + ( a hardware critical weight * a hardware critical percentage ) + ( a consistency critical weight * a consistency critical percentage ) ) = the overall risk \qquad ( Equation 1 )$$

where any of the critical weights (or “weights”), which can include a weight of a specific cluster, can be implemented as being any of the weights (e.g., the risk weight(s)), as discussed above with reference to FIG. 1, and any of the critical percentages can include a percentage of anomalies experienced by the specific cluster.

In some examples, any of the weights can include a weight of a classification (also referred to herein as a “cluster”). The weight of a cluster can be calculated according to an equation 2, shown below:

$$( an average anomaly risk weight of that cluster ) / ( a sum of average anomaly risk weights of all clusters ) = the weight of the cluster \qquad ( Equation 2 )$$

By way of example, a weight of a software critical cluster (e.g., a software critical weight) can be determined by dividing an average severity level of all software critical anomalies associated with the device 206, by a sum of an average severity level of all anomalies associated with all clusters associated with the device 206.

In some examples, a percentage occurrence of anomalies (e.g., a cluster critical percentage, such as a hardware critical percentage, a software critical percentage, or a consistency check critical percentage (or “consistency critical percentage”)) associated with a cluster can be calculated according to an equation 3, shown below:

$$( a number of anomalies occurring in a time interval from a cluster ) / ( a total number of anomalies occuring in the cluster during the time interval ) = the percentage occurance of anomalies . \qquad ( Equation 3 )$$

By way of example, a percentage occurrence of anomalies associated with a software cluster (e.g., a software critical percentage) can be calculated by dividing a number of software critical anomalies that occurred during a time interval (e.g., a time interval beginning at a time (e.g., a year, a month, a day, an hour, a second, a millisecond, etc.) and ending at another time (e.g., a year, a month, a day, an hour, a second, a millisecond, etc.))/a total number of all software critical anomalies associated with the device 206.

As a hypothetical example, with a total number of anomalies associated with a device occurring across all clusters including ″7, a number of anomalies in a software critical cluster include 5, a number of anomalies in a hardware critical cluster include 5, a number of anomalies in a consistency critical cluster include 7, and anomaly severity levels 1, 2, 3, being associated with weights, respectively, including 10, 5, and 1, a weight associated with each of the clusters can be calculated. An overall risk factor associated with the device can be calculated.

In the hypothetical example, a weight associated with each cluster can be calculated by identifying a severity level and a number of occurrences associated with each of the anomalies. The weight associated with each cluster can be calculated by, initially, calculating an average severity level for each cluster, then calculating an average of all of the severity levels for all clusters, then dividing the average severity level for each cluster by the average of all of the severity levels for all clusters, in order to ensure that the weight of each cluster is proportional to the average severity of all of the clusters. By way of example, anomalies may occur as shown in the tables 1-3, shown below:

TABLE 1
Software Critical Anomalies

| Severities | Sev1 | Sev1 | Sev1 | Sev2 | Sev3 |
|---|---|---|---|---|---|
| Weights | 10 | 10 | 10 | 5 | 1 |

TABLE 2
Hardware Critical Anomalies

| Severities | Sev1 | Sev1 | Sev1 | Sev2 | Sev3 |
|---|---|---|---|---|---|
| Weights | 5 | 5 | 5 | 1 | 1 |

TABLE 3
Consistency Critical Anomalies

| Severities | Sev1 | Sev2 | Sev3 | Sev3 | Sev3 | Sev3 | Sev3 |
|---|---|---|---|---|---|---|---|
| Weights | 10 | 5 | 1 | 1 | 1 | 1 | 1 |

where the severities (e.g., Sev1, Sev2, Sev3) indicate severity levels associated with each of the anomalies, and the weights (e.g., 10, 5, 1) indicate weights associated with each of the anomalies.

In the hypothetical example, an average anomaly risk weight of the software critical cluster can be determined as (10+10+10+5+1)/5=7.200000; an average anomaly risk weight of the hardware critical cluster can be determined as (5+5+5+5+1)/5=3.400000; and an average anomaly risk weight of the consistency critical cluster can be determined as (10+5+1+1+1+1+1+1)/7=2.857143. In the hypothetical example, a sum of the average severity risk weights of all clusters can be calculated as 7.200000+3.400000+2.857143=13.457142857142857.

In the hypothetical example, weights, which may include dynamic weights, can be calculated for each cluster. A weight of the software critical cluster can be calculated as 7.200000/13.457142857142857=0.53503; a weight of the hardware critical cluster can be calculated as 3.400000/13.457142857142857=0.252654; and weight of the consistency critical cluster can be calculated as 2.857143/13.457142857142857=0.212314.

In the hypothetical example, a percentage of all anomalies (e.g., a percentage occurrence) associated with each cluster can be calculated. For each cluster, a percentage occurrence can be calculated by dividing a number of occurrences of anomalies in the cluster (for a time interval) by a total number of anomalies in the cluster. For example, a number of software critical anomalies occurring by a time t1 may include 2; a number of hardware critical anomalies occurring by the time t1 may include 3; and a number of consistency critical anomalies occurring by the time t1 may include 3.

In the hypothetical example, the percentage occurrence may be calculated at a constant time interval by a controller (e.g., the controller 202). The time interval may include any interval, such as 1 min, 5 min. etc.

In the hypothetical example, the software critical percentage may be identified by dividing the 2 anomalies occurring at the time t1 by the 5 total software critical anomalies, as being 0.4 (or 40%); the hardware critical percentage may be identified by dividing the 3 anomalies occurring at the time t1 by the 5 total hardware critical anomalies, as being 0.6 (or 60%); and the consistency critical percentage may be identified by dividing the 3 anomalies occurring at the time t1 by the 7 total consistency critical anomalies, as being 0.4285 (or 42.85%).

In the hypothetical example, a severity level 1 (or “sev1”) risk (e.g., a risk factor associated with a severity level 1) (or “severity level 1 risk factor”) associated with the Sev1 anomalies can be calculated. With an example in which a total number of sev1 anomalies at the time t1 for all clusters includes 6, a total number of software critical anomalies at the time t1 for the software critical cluster includes 2, a total number of hardware critical anomalies at the time t1 for the software critical cluster includes 3, and a total number of software critical anomalies at the time t1 for the software critical cluster includes 5, the severity level 1 risk associated with the Sev1 anomalies can be calculated as 6/(2+3+5)=6/10=60%.

In the hypothetical example, the overall risk associated with the device can be calculated utilizing the weight of each of the clusters. The overall risk associated with the device can be identified via equation 1, as discussed above, by calculating ((0.53503*0.4)+(0.252654*0.6)+(0.212314*0.4285)=0.456581749 (45.65%).

A device (e.g., a router) being determined as being at risk can be based on both the overall risk and the sev1 anomalies risk percentage. If either the overall risk or the sev1 anomalies risk percentage is above a threshold, the controller (e.g., the controller 202) can identify (e.g., declare) the router to be at high risk. However, even if the overall risk is well within the threshold, the router may still be at risk if the percentage of sev1 anomalies is above the threshold, indicating that the router is vulnerable. The device may be declared as being at risk if an overall threshold is greater than or equal to a threshold (e.g., 60%) or if the sev1 risk percentage is greater than or equal to a threshold (e.g., 40%).

By maintaining a standard deviation between the weights, by assigning a weight quotient (e.g., a weight quotient that is appropriate) between the weights and different respective severity levels, false positive results may minimized. For examples, in a less than desirable instance, by assigning a weight of “1,” “2,” and “3” (instead of “1,” “5,” and “10”) to severity levels “3,” “2,” and “1,” an incorrect overall risk calculation may result. In particular, a severity 1 anomaly may have an impact of 10 severity 3 anomalies, making the weights of “1,” “5,” and “10” more accurate. However, weights may vary based on any needs of a network and requirements. The weights may be selected, for example, via user input to the controller 202.

In various implementations, one or more control signals 216 may be utilized to control one or more devices of the network(s) 204 based on the analysis information. In some examples, the control signal(s) 216 can include at least a portion of the risk analysis information 116, and/or be transmitted separately from the risk analysis information 116. The control signal(s) 216, in some examples, can be transmitted based on the risk analysis information 116.

The control signal(s) 216 may include device risk based traffic rerouting signals, and/or one or more data priority based traffic rerouting signals. The device risk based traffic rerouting signal(s) may be utilized to reroute data traffic to one or more other devices, based on the analysis information and/or the overall risk weight of the device 206 being greater than or equal to the other device(s).

The control signal(s) 216 can be transmitted, routed, etc., by the controller 202, and to the device 206, and/or at least one other device. In some examples, the control signal(s) 216 can be routed directed to the devices (e.g., the device 206 and/or to the at least one other device). In those or other examples, the control signal(s) 216 can be routed, via any of the device 206 and/or any number of the at least one other device, and to the device 206 and/or any number of the at least one other device. Any control signal(s) 216 received and/or routed by any device can be utilized by the device receiving and/or routing the control signal(s) 216 to manage data traffic (e.g., reroute data traffic), according to any of the techniques discussed herein.

In some examples, the data priority based traffic rerouting signal(s) may be utilized to reroute higher priority data traffic associated with the device 206, to one or more other devices. At least a portion of higher priority data traffic may be rerouted to the other device(s) based on the analysis information and/or the overall risk weight of the device 206 being greater than or equal to the other device(s). At least a portion of higher priority data traffic may remain routed through the device 206. The portion of higher priority data traffic being rerouted may be greater than the portion of the higher priority data traffic not being rerouted (e.g., remaining as being routed through the device 206).

In those or other examples, at least a portion of lower priority data traffic may remain routed through the device 206, and/or at least a portion of higher priority data traffic may remain routed through the device 206. The portion of the lower priority data traffic remaining routed through the device 206 may be greater than the portion of the lower priority data traffic being rerouted.

By rerouting higher priority data traffic, and/or rerouting a larger portion of higher priority data traffic, in some examples, than lower priority data traffic being rerouted, the device 206 may be utilized for lower priority data traffic more than for higher priority data traffic, based on the risk factor of the device 206 being greater than the risk factor of other devices. The device 206 may be utilized for less data traffic, overall, to reduce likelihoods of network problems.

The impact of traffic caused by various anomalies on all the routers may be dynamically managed by the controller 202, in real-time. The controller 202 may dynamically, in real-time, ensure that load balancing across the network(s) 204 is maintained. A wider range of constraints than in conventional technology may be utilized to provide a more comprehensive and optimized routing solution. Comprehensive network management, such as by utilizing the analysis information and the status data 208, can enable the controller 202 to utilizing additional constraints, aside from just bandwidth of the network(s) 204, to manage data traffic of the network(s) 204 more accurately and effectively. The controller 202 can identify the anomaly(ies) 210, such as any types of anomalies, including, and/or in addition to, path criticality.

The controller 202 can utilize the anomaly(ies) 210, which may include any types of anomalies that can make the device 206 (e.g., a router). The controller 202 can then compute the optimal routing plan associated with any data traffic, by balancing these competing demands associated with the devices of the network(s) 204 and the data traffic. Various routing plans for various data packets, data signals, data files, etc., can be identified by the controller 202 utilizing the analysis data. The controller 202 can identify anomalies at scale, as network sizes change, as numbers of devices change, as amounts of data traffic change, and/or as any other characteristics (e.g., network and/or device characteristics) change. The controller 202 can adopt as the changes occur, dynamically and in real-time, and update controlling based on the analysis information, accordingly.

In some examples, the controller 202 can switch between modes, including a mode for managing the network(s) 204 based on severity level 1 risks (e.g., a severity level 1 risk of a device, or one or more severity level 1 risks of one or more devices), a mode for managing the network (s) 204 based on overall risks (e.g., a risk factor of a device, or one or more risk factors of one or more devices), and/or a mode for managing the network based on both severity level 1 risks (e.g., a severity level 1 risk of a device, or one or more severity level 1 risks of one or more devices) and overall risks (e.g., a risk factor of a device, or one or more risk factors of one or more devices).

In some examples, by switching between management based on severity level 1 risks and overall risks, the controller 202 may control traffic to a device (e.g., a switch or a router) with a severity 1 risk, such as by the controller 202 routing less overall traffic or less high priority traffic to the, even if the device has a low overall number of risks. In those or other examples, the controller 202 may control traffic to a device (e.g., a switch or a router) with a large overall risk (e.g., a larger number of lower severity anomalies), such as by the controller 202 routing less overall traffic or less high priority traffic to the device.

By utilizing the controller 202 to manage the network(s) 204, and/or devices therein, a user (e.g., an administrator), via one or more user selections to the controller 202, for example, may customize control and/or management. For example, administrator may input the selection(s) to select a “risk appetite” for the network(s) 204. In other examples, depending on the criticality of network traffic, the network administrator can adjust values, such as the weights used in an algorithm (e.g., the equations 1-3, discussed above) for identifying the analysis information to operate the network(s) 204 according to different risk levels. Default values may be provided in our algorithm, but the user can adjust the values.

In those or other examples, different severity levels, other than sev1, sev2, sev3, may be used and/or selected, and any number of severity levels may be used and/or selected. In those or other examples, other weights at different proportions (e.g., weight quotient) for the severity levels may be used and/or selected, and/or other numbers of weights may be utilized. In those or other examples, other clusters may be utilized and/or selected, in addition to, or aside from, software, hardware, and consistency clusters. In those or other examples, any number of clusters maybe be used and/or selected.

The controller 202 may be utilized, such as by a network administrator, to periodically monitor the network(s) 204 (e.g., such as monitoring through individual switches). The controller 202 can display information utilized by the network administrator to assess a state of the network(s) 204. The administrator may, via user input, select various intervals for obtaining the status data 208 and/or identifying the analysis information. The controller 202 may utilize different risk levels at different times of a day, such as to lower a risk level during periods of heavy traffic or higher priority traffic. The controller 202 can provide visibility of the network by displaying the status data 208 and/or the analysis information, via a display. By way of example, the risk levels can be adjusted (e.g., lowered) during high priority traffic (e.g., stock-exchange related traffic) to ensure the network is more reliable, by limiting the risk levels and rerouting data based on severity 1 risks and/or risk factors of any devices being relatively higher.

Although risk factors, including severity 1 risk factors and overall risk factors are utilized, as discussed above in the current disclosure, it is not limited as such. In some examples, any functions performed utilizing the overall risk factors can be performed in a similar way utilizing the severity 1 risk factors, and vice versa, for purposes of implementing any of the techniques discussed herein.

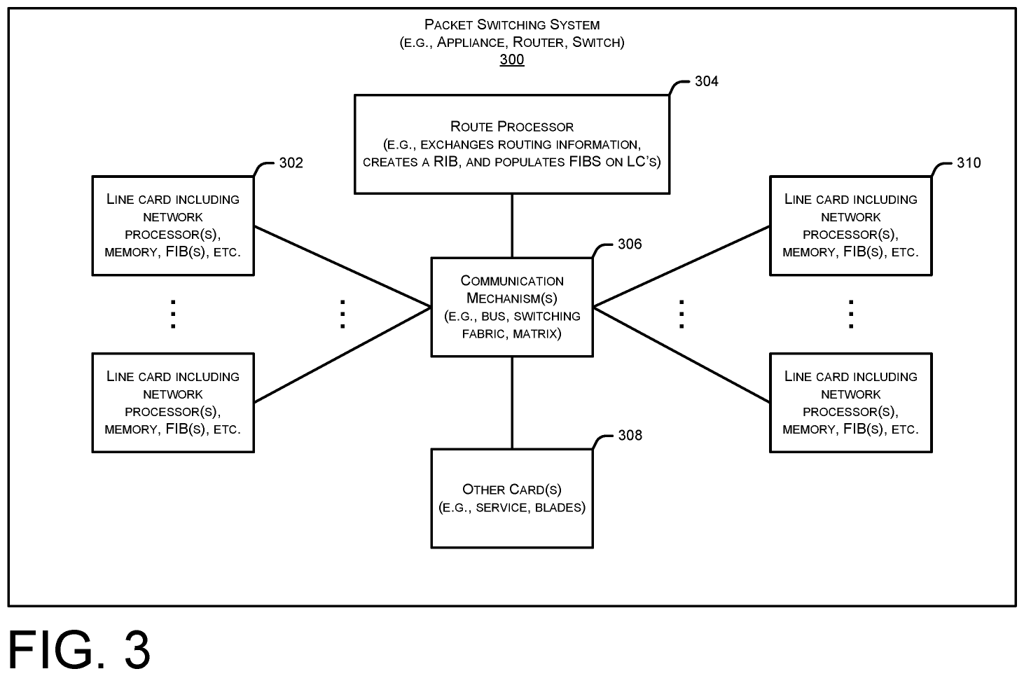

FIG. 3 illustrates a block diagram illustrating an example packet switching system that can be utilized to implement various aspects of the technologies disclosed herein. In some examples, packet switching device(s) 400 may be employed in various networks, such as, for example, network(s) 104 as discussed above with respect to FIG. 1. In those or other examples, any of one or more portions of the packet switching device(s) 400 may be utilized to implement one or more of devices (e.g., the switch(es) 108, the router(s) 110, etc., and/or one or more of any other of devices of various types) of the computing and networking architecture 100 as discussed above with respect to FIG. 1.

In some examples, a packet switching device 300 may comprise multiple line card(s) 302, 310, each with one or more network interfaces for sending and receiving packets over communications links (e.g., possibly part of a link aggregation group). The packet switching device 300 may also have a control plane with one or more processing elements 304 for managing the control plane and/or control plane processing of packets associated with forwarding of packets in a network. The packet switching device 300 may also include other cards 308 (e.g., service cards, blades) which include processing elements that are used to process (e.g., forward/send, drop, manipulate, change, modify, receive, create, duplicate, apply a service) packets associated with forwarding of packets in a network. The packet switching device 300 may comprise hardware-based communication mechanism 306 (e.g., bus, switching fabric, and/or matrix, etc.) for allowing its different entities 302, 304, 308 and 310 to communicate. Line card(s) 302, 310 may typically perform the actions of being both an ingress and/or an egress line card 302, 310, in regard to multiple other particular packets and/or packet streams being received by, or sent from, packet switching device 300.

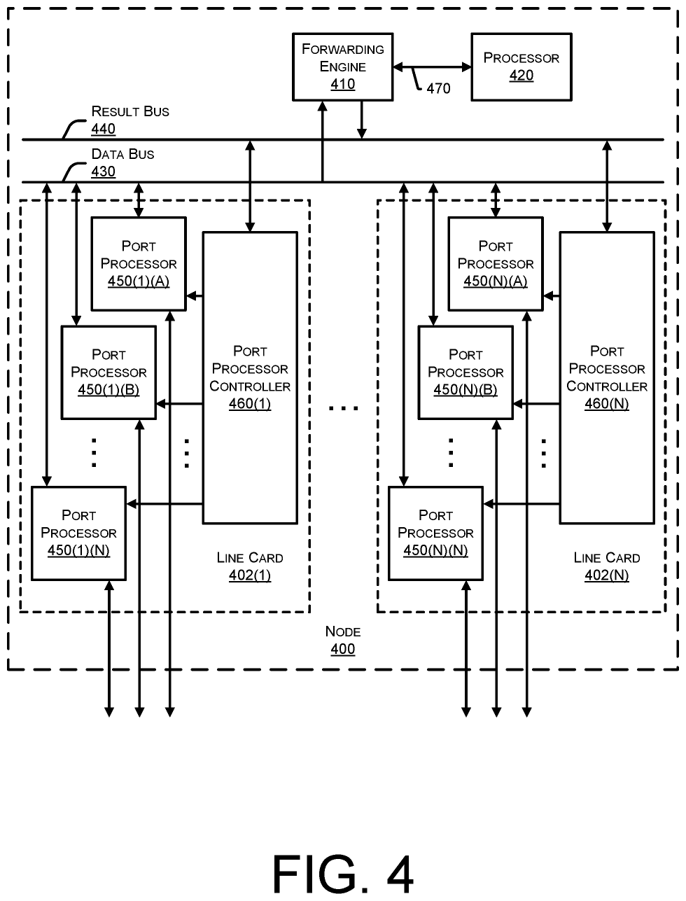

FIG. 4 illustrates a block diagram illustrating certain components of an example node that can be utilized to implement various aspects of the technologies disclosed herein. In some examples, node(s) 400 may be employed in various networks, such as, for example, network(s) 104 as discussed above with respect to FIG. 1.

In some examples, node 400 may include any number of line cards 402 (e.g., line cards 402(1)-(N), where N may be any integer greater than 1) that are communicatively coupled to a forwarding engine 410 (also referred to as a packet forwarder) and/or a processor 420 via a data bus 430 and/or a result bus 440. Line cards 802(1)-(N) may include any number of port processors 450(1)(A)-(N)(N) which are controlled by port processor controllers 460(1)-(N), where N may be any integer greater than 1. Additionally, or alternatively, forwarding engine 410 and/or processor 420 are not only coupled to one another via the data bus 430 and the result bus 440, but may also communicatively coupled to one another by a communications link 470.

The processors (e.g., the port processor(s) 450 and/or the port processor controller(s) 460) of each line card 402 may be mounted on a single printed circuit board. When a packet or packet and header are received, the packet or packet and header may be identified and analyzed by node 400 (also referred to herein as a router) in the following manner. Upon receipt, a packet (or some or all of its control information) or packet and header may be sent from one of port processor(s) 450(1)(A)-(N)(N) at which the packet or packet and header was received and to one or more of those devices coupled to the data bus 830 (e.g., others of the port processor(s) 450(1)(A)-(N)(N), the forwarding engine 410 and/or the processor 420). Handling of the packet or packet and header may be determined, for example, by the forwarding engine 410.

For example, the forwarding engine 410 may determine that the packet or packet and header should be forwarded to one or more of port processors 450(1)(A)-(N)(N). This may be accomplished by indicating to corresponding one(s) of port processor controllers 460(1)-(N) that the copy of the packet or packet and header held in the given one(s) of port processor(s) 450(1)(A)-(N)(N) should be forwarded to the appropriate one of port processor(s) 450(1)(A)-(N)(N).

Additionally, or alternatively, once a packet or packet and header has been identified for processing, the forwarding engine 410, the processor 420, and/or the like may be used to process the packet or packet and header in some manner and/or maty add packet security information in order to secure the packet. On a node 400 sourcing such a packet or packet and header, this processing may include, for example, encryption of some or all of the packet's or packet and header's information, the addition of a digital signature, and/or some other information and/or processing capable of securing the packet or packet and header. On a node 400 receiving such a processed packet or packet and header, the corresponding process may be performed to recover or validate the packet's or packet and header's information that has been secured.

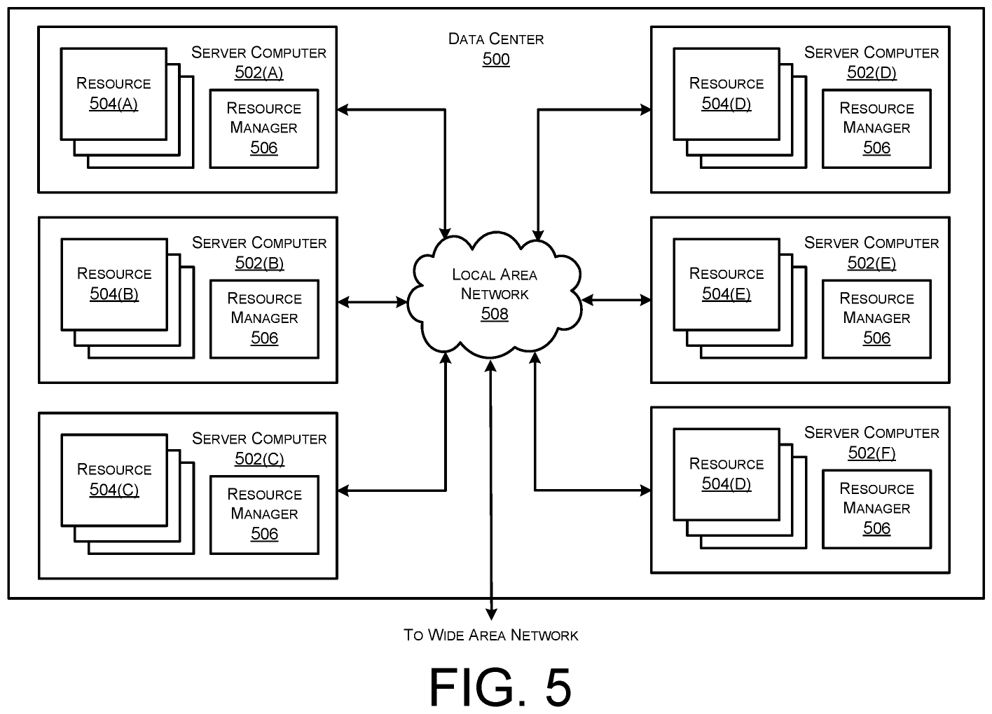

FIG. 5 is a computing system diagram illustrating a configuration for a data center 500 that can be utilized to implement aspects of the technologies disclosed herein. The example data center 500 shown in FIG. 5 includes several server computers 502A-502F (which might be referred to herein singularly as “a server computer 502” or in the plural as “the server computers 502”) for providing computing resources. In some examples, the resources and/or the server computers 502 may include, or correspond to, the any type of networked device described herein. Although described as servers, the server computers 502 may comprise any type of networked device, such as servers, switches, routers, hubs, bridges, gateways, modems, repeaters, access points, etc. In those or other examples, the resources and/or the server computers 502 may include, or correspond to, the controller(s) 102 and/or the controller 202, as discussed above with respect to FIGS. 1 and 2.

The server computers 502 can be standard tower, rack-mount, or blade server computers configured appropriately for providing the computing resources described. In some examples, the server computers 502 may provide computing resource network 504, which can include data processing resources such as VM instances or hardware computing systems, database clusters, computing clusters, storage clusters, data storage resources, database resources, networking resources, and others. Some of the servers 502 can also be configured to execute a resource manager capable of instantiating and/or managing the computing resources. In the case of VM instances, for example, the resource manager can be a hypervisor or another type of program configured to enable the execution of multiple VM instances on a single server computer 502. Server computers 502 in the data center 500 can also be configured to provide network services and other types of services.

In the example data center 500 shown in FIG. 5, an appropriate local area network (LAN) 504 is also utilized to interconnect the server computers 502A-502E, and to connect the server computers 502A-502E to a wide area network (WAN), the network(s) 104, and/or the network(s) 204, as discussed above with reference to FIGS. 1 and 2. In various examples, the WAN can be integrated within, or be separate from, the network(s) 104 and/or the network(s) 204. In various examples, one or more data centers (e.g., any number of data centers similar to the data center 500), and/or one or more other computing devices communicatively coupled thereto, can be utilized to implement, and/or to manage (e.g., identify, determine, generate, compare, process, store, transmit, receive, route, etc., or any combination thereof) data for, any portions of the network(s) 104, the network(s) 204, the system(s), the device(s) therein, the other networks, the other systems, and the other device(s) therein, as discussed above with respect to FIGS. 1 and 2.

It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 500, between each of the server computers 502A-502F in each data center 500, and, potentially, between computing resources 504 in each of the server computers 502. It should be appreciated that the configuration of the data center 500 described with reference to FIG. 5 is merely illustrative and that other implementations can be utilized.

In some examples, the server computers 502 may each execute virtual machines to perform techniques described herein. In some instances, the data center 500 may provide the computing resources 504, like application containers, VM instances, and storage, on a permanent or an as-needed basis. Among other types of functionality, the computing resources 504 may be provided by a cloud computing network and may be utilized to implement the various services and techniques described above. The computing resources 504 provided by the controller(s) 102 and/or the network(s) 104 can include various types of computing resources, such as data processing resources like application containers and VM instances, data storage resources, networking resources, data communication resources, network services, and the like.

Each type of computing resource provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 504 not mentioned specifically herein.

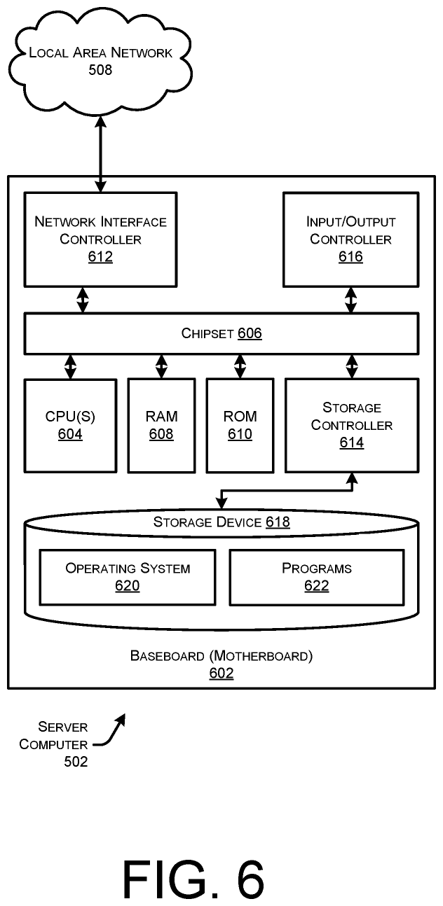

The computing resources 504 provided by the cloud computing network may be enabled in one embodiment by one or more data centers 500 (which might be referred to herein singularly as “a data center 500” or in the plural as “the data centers 500”). The data centers 500 are facilities utilized to house and operate computer systems and associated components. The data centers 500 typically include redundant and backup power, communications, cooling, and security systems. The data centers 500 can also be located in geographically disparate locations. One illustrative embodiment for a data center 500 that can be utilized to implement the technologies disclosed herein will be described below with regard to FIG. 6.

FIG. 6 shows an example computer architecture for a server computer 502 capable of executing program components for implementing the functionality described above. The computer architecture shown in FIG. 6 illustrates a conventional server computer, workstation, desktop computer, laptop, tablet, network appliance, e-reader, smartphone, or other computing device, and can be utilized to execute any of the software components presented herein. The server computer 502 may, in some examples, correspond to a physical server and may comprise networked devices such as servers, switches, routers, hubs, bridges, gateways, modems, repeaters, access points, etc.

The computer 502 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computing device 502.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computing device 502. The chipset 606 can further provide an interface to a computer-readable storage medium such as a read-only memory (“ROM”) 610 or non-volatile RAM (“NVRAM”) for storing basic routines that help to startup the computing device 502 and to transfer information between the various components and devices. The ROM 610 or NVRAM can also store other software components necessary for the operation of the computing device 502 in accordance with the configurations described herein.

The computer 502 can operate in a networked environment using logical connections to remote computing devices and computer systems through a network, such as the network(s) 104. The chipset 606 can include functionality for providing network connectivity through a NIC 612, such as a gigabit Ethernet adapter. The NIC 612 is capable of connecting the computer 502 to other computing devices over the network 508 (and/or the network(s) 104). It should be appreciated that multiple NICs 612 can be present in the computer 502, connecting the computer to other types of networks and remote computer systems.

The computer 502 can be connected to a storage device 618 that provides non-volatile storage for the computer 502. The storage device 618 can store an operating system 620, programs 622, and data, which have been described in greater detail herein. The storage device 618 can be connected to the computer 502 through a storage controller 614 connected to the chipset 606. The storage device 618 can consist of one or more physical storage units. The storage controller 614 can interface with the physical storage units through a serial attached SCSI(“SAS”) interface, a serial advanced technology attachment (“SATA”) interface, a fiber channel (“FC”) interface, or other type of interface for physically connecting and transferring data between computers and physical storage units.

The computer 502 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 502 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 502 can further read information from the storage device 618 by detecting the physical states or characteristics of one or more particular locations within the physical storage units.

In addition to the mass storage device 618 described above, the computer 502 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 502. In some examples, the operations performed by the computing and networking architecture 100, and or any components included therein, may be supported by one or more devices similar to computer 502. Stated otherwise, some or all of the operations performed by the computing and networking architecture 100, and or any components included therein, may be performed by one or more computer 502 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 502. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 502.

In one embodiment, the storage device 618 or other computer-readable storage media is encoded with computer-executable instructions which, when loaded into the computer 502, transform the computer from a general-purpose computing system into a special-purpose computer capable of implementing the embodiments described herein. These computer-executable instructions transform the computer 502 by specifying how the CPUs 604 transition between states, as described above. According to one embodiment, the computer 502 has access to computer-readable storage media storing computer-executable instructions which, when executed by the computer 502, perform the various processes described above with regard to FIGS. 1-5. The computer 502 can also include computer-readable storage media having instructions stored thereupon for performing any of the other computer-implemented operations described herein.

The computer 502 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 502 might not include all of the components shown in FIG. 6, can include other components that are not explicitly shown in FIG. 6, or might utilize an architecture completely different than that shown in FIG. 6.

As described herein, one or more computers (e.g., the computer 502 and/or one or more other computers) may comprise one or more the device(s) as discussed above with reference to FIG. 1. In various examples, the computer(s) may comprise the switch(es) 108, the router(s) 110, the computing device(s) 112 and/or 114, and/or one or more of any other of the device(s) in the computing and networking architecture 100. The computer(s) may include one or more hardware processors (processors) configured to execute one or more stored instructions. The processor(s) may comprise one or more cores. Further, the computer(s) may include one or more network interfaces configured to provide communications between the computer(s) and other devices, such as the communications described herein as being performed by the switch(es) 108, the router(s) 110, the computing device(s) 112 and/or 114, and/or one or more of any other of the device(s). The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs may comprise any type of programs or processes to perform the techniques described in this disclosure for providing risk analysis based network and system management. The programs may comprise any type of program that cause the computer(s) to perform techniques for communicating with other devices using any type of protocol or standard usable for determining connectivity.

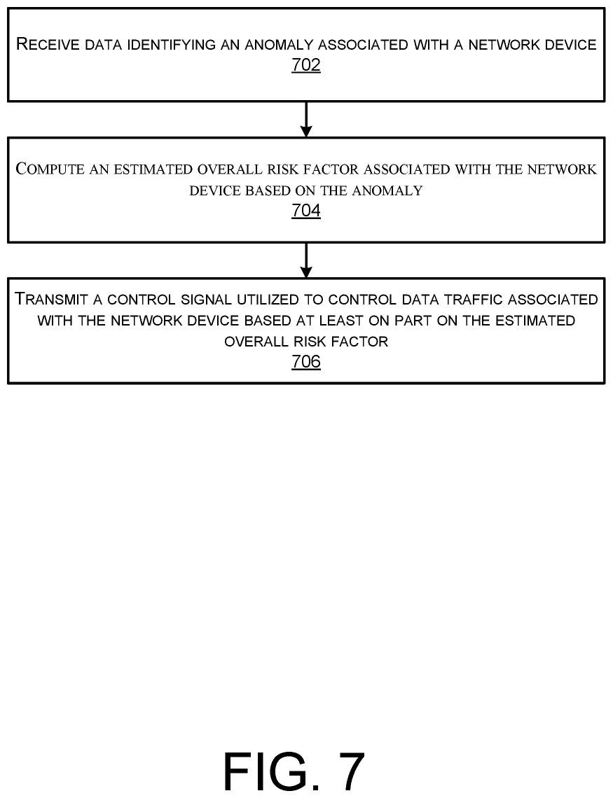

FIG. 7 illustrates a flow diagram of an example method that illustrates aspects of the functions performed at least partly by the devices in the computing and networking architecture as described in FIG. 1.

At 702, a controller 102 can receive data identifying an anomaly associated with a network device. The anomaly characteristic can include at least one of an identifier, a classification, or a severity associated with the anomaly. The classification can include a software critical classification, a hardware critical classification, and a consistency critical classification.

At 704, the controller 102 can compute an estimated overall risk factor associated with the network device based on the anomaly. Computing of the estimated overall risk factor can include computing a severity level associated with the anomaly, computing a percentage of occurrences of anomalies in a classification with the anomaly, computing anomaly risk weights of anomalies in the classification with the anomaly based on the severity levels, computing a classification risk weight based on an average the anomaly risk weights, and computing the estimated overall risk factor based at least in part on the classification risk weight. A severity level 1 risk factor can be computed based on severity level 1 anomalies for the classification.

At 706, the controller 102 can transmit a control signal utilized to control data traffic associated with the network device based at least on part on the estimated overall risk factor. The controller 102 can reroute traffic based on the estimated overall risk factor and/or the severity level 1 risk factor being above corresponding thresholds, to divert relatively higher priority traffic away from the network device. Additionally or alternatively, traffic (e.g., the relatively higher priority traffic, and/or other traffic) can be diverted to relatively lower risk network devices.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIG. 7 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less, or more, components.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method, comprising:
receiving anomaly data associated with a network device;
identifying anomaly characteristic information associated with the anomaly data;
computing estimated overall risk factor information associated with the network device based on the anomaly data and the anomaly characteristic information; and
transmitting a control signal utilized to control data traffic associated with the network device based on the estimated overall risk factor information.

2. The method of claim 1, further comprising:
identifying an anomaly indicated via the anomaly data,
wherein the anomaly characteristic information includes at least one of an identifier, a classification, or a severity associated with the anomaly.

3. The method of claim 2, wherein computing the estimated overall risk factor information further comprises:
computing a severity level associated with an anomaly indicated via the anomaly data;
identifying a number of occurrences of the anomaly;
computing a risk weight based on the severity level and the number of occurrences;
computing an anomaly frequency of a classification associated with the anomaly; and
computing an estimated overall risk factor of the estimated overall risk factor information based on the risk weight and the anomaly frequency.

4. The method of claim 1, wherein the network device is a first network device that is a high risk network device, and transmitting the control signal further comprises:
transmitting the control signal to a second network device, the control signal being utilized to instruct the second network device to at least one of i) reroute the data traffic to a third network device that is a low risk network device, or ii) reroute high risk data traffic from among the data traffic.

5. The method of claim 1, wherein an anomaly indicated via the anomaly data comprises at least one of i) a behavior of a behavior type that is not included from among a group of approved behavior types, or ii) an operation of an operation type that is not included from among a group of approved operation types.

6. The method of claim 1, further comprising:
identifying an anomaly indicated via the anomaly data,
wherein the anomaly characteristic information includes an anomaly classification from among a group of classifications, the group of classifications includes at least one of a software error classification, a hardware error classification, or a consistency check classification.

7. The method of claim 1, wherein computing the estimated overall risk factor information further comprises:
computing a severity level associated with a first anomaly indicated via the anomaly data;
computing a percentage of occurrences of the first anomaly indicated via the anomaly data;
computing a first risk weight based on the severity level and the percentage of occurrences; and
computing an estimated overall risk factor of the estimated overall risk factor information based on the first risk weight and a second risk weight, the second risk weight being associated with a second anomaly of a different type than the first anomaly.

8. A system, comprising:
one or more processors; and
one or more non-transitory computer-readable media storing computer-executable instructions that, when executed by the one or more processors, cause the one or more processors to perform operations comprising:
receiving data identifying an anomaly associated with a network device;
computing an estimated overall risk factor associated with the network device based on the anomaly; and
transmitting a control signal utilized to control data traffic associated with the network device based at least on part on the estimated overall risk factor.

9. The system of claim 8, the operations further comprising:
identifying at least one anomaly characteristic associated with the anomaly,
wherein the at least one anomaly characteristic includes at least one of an identifier, a classification, or a severity associated with the anomaly.

10. The system of claim 9, wherein computing the estimated overall risk factor further comprises:
computing a severity level associated with the anomaly;
identifying a number of occurrences of the anomaly; and
computing the estimated overall risk factor based at least on part on the severity level and the number of occurrences.

11. The system of claim 8, wherein computing the estimated overall risk factor further comprises:
identifying a number of occurrences of anomalies in a cluster that comprises the anomaly identified by the data, based at least in part on a time interval in which the anomalies occur;
identifying a total number of occurrences of anomalies in the cluster during the time interval;
computing a percentage of occurrences of the cluster based at least in part on the number of occurrences and a total number of occurrences; and
computing the estimated overall risk factor based at least on part on the percentage of occurrences of the cluster.

12. The system of claim 8, wherein the anomaly is included in a cluster from among a group of clusters, and the group of clusters include a software critical cluster, a hardware critical cluster, and a consistency critical cluster.

13. The system of claim 8, wherein computing the estimated overall risk factor further comprises:
computing a severity level associated with the anomaly;
computing a percentage of occurrences of the anomaly;
computing a risk weight of the anomaly based on the severity level; and
computing the estimated overall risk factor based at least in part on the risk weight.

14. The system of claim 8, wherein the network device is a first network device, and transmitting the control signal further comprises:
transmitting the control signal to a second network device, the control signal being utilized to instruct the second network device to at least one of i) reroute the data traffic to a third network device, or ii) reroute a portion of the data traffic.

15. A system, comprising:
a control device;
a network device;
one or more processors; and
one or more non-transitory computer-readable media storing computer-executable instructions that, when executed by the one or more processors, cause the one or more processors to perform operations comprising:
receiving anomaly data associated with the network device;
identifying anomaly characteristic information associated with the anomaly data;
computing estimated overall risk factor information associated with the network device based on the anomaly characteristic information; and
transmitting, to the control device, a control signal utilized to at least one of control another network device or reroute data traffic based on the estimated overall risk factor information.

16. The system of claim 15, wherein the anomaly characteristic information includes an identifier, a classification, and a severity associated with an anomaly indicated in the anomaly data.

17. The system of claim 15, wherein computing the estimated overall risk factor information further comprises:
computing a severity level based at least in part on the anomaly data;
identifying a number of occurrences of an anomaly indicated in the anomaly data;
computing a risk weight based on the severity level;
computing an anomaly frequency of a classification associated with the anomaly; and
computing an estimated overall risk factor of the estimated overall risk factor information based at least in part on the risk weight and the anomaly frequency.

18. The system of claim 15, wherein the network device is a first network device that is a high risk network device, and transmitting the control signal further comprises:
transmitting the control signal to a second network device, the control signal being utilized to instruct the second network device to reroute the data traffic to a third network device that is a low risk network device.

19. The system of claim 15, wherein the network device is a first network device, and transmitting the control signal further comprises:
transmitting the control signal to a second network device, the control signal being utilized to instruct the second network device to reroute high risk data traffic from among the data traffic.

20. The system of claim 15, wherein the network device is a first network device, the control signal is a first control signal,
wherein transmitting the first control signal further comprises:
transmitting, to the control device, the first control signal, the first control signal being routed by the control device to a second network device,
the operations further comprising:
transmitting, to the control device, a second control signal, the second control signal being routed by the control device to a third network device, the second network device and the third network device being utilized to control data traffic associated with the first network device.
